(19) United States
(12) Patent Application Publication
(10) Pub. No.: US 2010/0088250 A1
(43) Pub. Date: Apr. 8, 2010

(54) Auction Method and Platform

(75) Inventors: Douglas Magnolia, New York, NY (US); Russel Francesco Parentela, Spring Lake, NJ (US); John Gagliardo, Lynbrook, NY (US); Priya Kudrako, Los Angeles, CA (US)

Correspondence Address: PILLSBURY WINTHROP SHAW PITTMAN, LLP, P.O. BOX 10500, MCLEAN, VA, 22102, US

(73) Assignee: THE BANK OF NEW YORK MELLON, New York, NY (US)

(21) Appl. No.: 12/573,638

(22) Filed: Oct. 5, 2009

Related U.S. Application Data
(60) Provisional application No. 61/102,711, filed on Oct. 3, 2008.

(51) Int. Cl. G06Q 40/00; G06F 17/30; G06F 17/40

(52) U.S. Cl. 705/36 R; 705/37; 707/E17.044

(57) ABSTRACT

A computer system and method evaluates and auctions financial instruments on a networked auction platform. The auction platform may be accessed via the Internet. Auction participants that have provided required participant information are registered in a database, and may include one or more registered sellers and registered buyers. An inventory of a registered seller's financial instruments is received and stored via the auction platform. An auction event is initiated the inventoried financial instruments in response to an auction request. Direct, integrated access is provided to a data and analytics tool that provides cash flow modeling that allows investment cash flow analysis and assessment of underlying risk of default based upon assumptions input by a registered buyer and past performance data. The cash flow analysis and risk assessment may be used by the registered buyer to determine a bid price or bid range for the financial instrument, or a decision not to bid may be made.

### CROSS-REFERENCE TO RELATED APPLICATIONS

This application claims benefit under 35 U.S.C. §119(e) to co-pending U.S. provisional application 61/102,711 filed on Oct. 3, 2008 and entitled “Exchange System and Method”. The entire contents of this application are incorporated herein by reference.

### BACKGROUND

This disclosure relates to a computerized system and method for providing transparency and reliable price discovery in the global market of structured credit and related financial instruments. This disclosure is further directed to a computer-implemented auction platform system and method that provides a solution capable of offering a global securities auction platform for illiquid assets in order to create market transparency, foster liquidity and generate revenues through commissions, licenses, and value added services and increase assets under custody. Embodiments of this disclosure will help buyers and sellers to interact in a single marketplace, obtain equal access to data and improve price discovery, and can provide a uniform exit strategy for government entities that are engaged in economic relief programs such as Term Asset-Backed Securities Loan Facility (TALF), and Troubled Asset Relief Program (TARP).

Structured finance is a broad term used to describe a sector of finance that was created to help transfer risk using complex legal and corporate entities. This risk transfer as applied to securitization of various financial assets (e.g. mortgages, credit card receivables, auto loans, etc.) has helped to open up new sources of financing to consumers and businesses. However, it has arguably contributed to the degradation in underwriting standards for these financial assets, which helped give rise to both the credit bubble of the mid-2000s and the credit crash and financial crisis of 2007-2009.

Structured finance encompasses all advanced private and public financial arrangements that serve to efficiently refinance and hedge any profitable economic activity beyond the scope of conventional forms of on-balance sheet securities (debt, bonds, equity) at lower capital cost and agency costs from market impediments on liquidity. In particular, most structured investments (i) combine traditional asset classes with contingent claims, such as risk transfer derivatives and/or derivative claims on commodities, currencies or receivables from other reference assets, or (ii) replicate traditional asset classes through synthesis or new financial instruments. Structured finance is invoked by financial and non-financial institutions in both banking and capital markets if established forms of external finance are either (i) unavailable (or depleted) for a particular financing need, or (ii) traditional sources of funds are too expensive for what would otherwise be an unattractive investment based on the issuer's desired cost of capital.

Structured finance offers issuers enormous flexibility to create securities with distinct risk-return profiles in terms of maturity structure, security design, and asset type, providing enhanced return at a customized degree of diversification commensurate to an individual investor's appetite for risk. Hence, structured finance contributes to a more complete capital market by offering any mean-variance trade-off along the efficient frontier of optimal diversification at lower transaction cost. However, the increasing complexity of the structured finance market, and the ever growing range of products being made available to investors, invariably create challenges in terms of efficient assembly, management and dissemination of information.

In the current structured credit market, there are several key industry challenges. These include buyers and sellers being disconnected due to market constraints, particularly in light of the recent departure of several key broker-dealers from the market. Further, there is limited access to standardized underlying data and benchmark pricing methodologies for the investment community at large, other than large players who have the means to build their own solutions. Even with the current wealth of data and analytic tools available in the market, the process of capturing, normalizing and analyzing data remains extremely fragmented because no single source solution has been developed. Government specific challenges also exist in that government programs, e.g., Federal Deposit Insurance Corporation (FDIC), Treasury, and the Federal Reserve, are accumulating large portfolios of troubled assets, and formalized plans to dispose of these assets do not exist or are still in the developmental stages and, as a result, tax payers not receiving sufficient value for their investments.

Structured credit markets are still highly illiquid, and there are no current solutions that would result in a restarting of the primary and secondary markets and increase liquidity which would benefit all participants in the structured credit market. In addition, there is no clear mechanism to deliver price discovery and transparency.

The global credit crisis, which had it's origins in the stress of the U.S. Subprime Mortgage Backed Securities (MBS) market, and which quickly spread to other structured credit products in the 3rd quarter of 2007, has not run its course yet, and continues to plague the Global economy. Market participants looking for answers are turning to the easiest deficiency to identify, which is a lack of transparent information, or rather the implied lack thereof, as the root cause to the worldwide economic situation. On the contrary, it could be argued that there actually is too much information available due to the lack of structure of the data. Not only is there too much data, but it is in numerous formats, comes at different times, has complex financial and mathematical concepts at their core that are subject to vagaries in definition, understanding, and ultimately, interpretation.

As this market evolved in the mid-nineties through to the early 2000's, deals became more complex and investors grew more complacent as more cash in the system chased fewer investments and ever higher returns on investment. This inevitably led, as in every credit cycle, to lowering of credit standards and riskier lending practices. A seesaw stays balanced when the inputs on both sides stay in synch, but as soon as one becomes too light, or too heavy, balance is lost and the heavy side crashes to the ground. This is effectively what happened as investors/buy-side withdrew from certain liquid paper, notably asset backed commercial paper. The complex domino chain reaction that this set off—fear, confusion, falling prices, and dried up liquidity—turned into a stalemate.

The global financial system today has evolved into an intricate interwoven “engine” that needs buyers and sellers to participate along with lenders and borrowers. By way of analogy, as oil in the engine dried up, the engine came to a halt. There was, and is still, plenty of gas (cash available for investment), but drivers have lost confidence in the ability for the engine to perform. So the car has been taken off the road and is awaiting a mechanic to fix it.

The root causes of the current situation are fourfold: fragmented market, lack of standard pricing mechanics, disconnected buyers and sellers, and voluminous but scattered inconsistent data.

Regulators, politicians, industry groups, consumers, big companies and small companies are all looking at ways to fix the engine and get the car back on the road.

“Transparency” in the marketplace continues to make headlines daily, but there are few if any panaceas. The response of industry has been fragmented and slightly confused due to concerns of regulatory oversight and the fact that many of the firms who would or could provide solutions are fighting to clean up their own balance sheets, raise capital, evaluate their own business models and get themselves back on track.

What is needed is a system and method that responds to the market need for transparency and which improves investor confidence in the ultimate price determination of structured products to facilitate financial liquidity of financial instruments. What is further needed is a system and method that addresses key elements associated with trading of so-called “troubled assets”, including data and data normalization, aggregation, drill down reporting, and price discovery. What is even further needed is a computer-implemented system and method for auctioning structured financial products including “troubled assets”, and which provides integrated tools for price discovery and risk determination to increase investor confidence.

### SUMMARY

This disclosure provides various embodiments and aspects of a system and method for creating an online auction platform that improves pricing by attracting buyers and creating competition. In one aspect, this disclosure provides a system and method for creating a global auction platform of so-called “troubled assets” which conventionally have been difficult, if not impossible, to accurately determine a price or attempt price discovery.

In one embodiment, a computer-implemented method of evaluating and auctioning financial instruments on an auction platform includes the steps of providing a processor, memory device, at least one user interface, and a network connection operatively interconnected in the auction platform; registering, in a database in the memory device, auction participants that have provided required participant information via the auction platform, said auction participants at least comprising one or more registered sellers and/or one or more registered buyers; storing, in the database, an inventory of financial instruments received from a registered seller via the auction platform; initiating an auction event for a selected one or more of the inventoried financial instruments in response to an auction request received from the registered seller via the auction platform; providing integrated direct access for a registered buyer to a data and analytics tool via the auction platform, said data and analytics tool comprising computer-implemented cash flow modeling that enables the registered buyer to carry out investment cash flow analysis and to assess underlying risk of default associated with the selected one or more of the inventoried financial instruments based upon one or more assumptions input to the auction platform by the registered buyer and past performance data related to the selected one or more of the inventoried financial instruments, wherein said cash flow analysis and said underlying risk assessment are used by said registered buyer to determine a bid price or bid range for said selected one or more of the inventoried financial instruments.

In another embodiment, a system for computerized evaluation and auctioning of financial instruments includes an auction platform comprising an operatively interconnected processor, a memory device, at least one user interface, and a network connection; a structured database arranged in the memory device and configured to store registration information received over the network connection, said registration information pertaining to auction participants that have provided required participant information via the auction platform, said auction participants at least comprising one or more registered sellers and/or one or more registered buyers; wherein the processor is configured to store, in the database, an inventory of financial instruments received from a registered seller via the auction platform and to initiate an auction event for a selected one or more of the inventoried financial instruments in response to an auction request received from the registered seller via the auction platform; and a computer interface to an integrated data and analytics tool, said integrated data and analytics tool providing direct access for a registered buyer to a computer-implemented cash flow model that enables the registered buyer to carry out investment cash flow analysis and to assess underlying risk of default associated with the selected one or more of the inventoried financial instruments based upon one or more assumptions input to the integrated data and analytics tool via the computer interface and past performance data related to the selected one or more of the inventoried financial instruments, wherein said cash flow analysis and said underlying risk assessment are used by said registered buyer to determine a bid price or bid range for said selected one or more of the inventoried financial instruments.

In another embodiment, an article of manufacture comprises a tangible computer-readable medium therein, said computer-readable medium containing computer-readable instructions thereon which, when executed by a computer processor, cause the processor to carry out functions related to evaluating and auctioning financial instruments on an auction platform, wherein the functions include registering, in a database in a memory device, auction participants that have provided required participant information via the auction platform, said auction participants at least comprising one or more registered sellers and/or one or more registered buyers; storing, in the database, an inventory of financial instruments received from a registered seller via the auction platform; initiating an auction event for a selected one or more of the inventoried financial instruments in response to an auction request received from the registered seller via the auction platform; providing integrated direct access for a registered buyer to a data and analytics tool via the auction platform, said data and analytics tool comprising computer-implemented cash flow modeling that enables the registered buyer to carry out investment cash flow analysis and to assess underlying risk of default associated with the selected one or more of the inventoried financial instruments based upon one or more assumptions input to the auction platform by the registered buyer and past performance data related to the selected one or more of the inventoried financial instruments, wherein said cash flow analysis and said underlying risk assessment are used by said registered buyer to determine a bid price or bid range for said selected one or more of the inventoried financial instruments.

Improved investor confidence in credit markets is achieved by one or more embodiments of this disclosure in which various services are incorporated in a networked electronic auction platform for primary and secondary markets in structured products, e.g., in MBS, RMBS, CMBS, CDO, ABS, or other structured credit arrangements. The network may be the Internet. Promoting liquidity for the fixed income, and particularly the structured credit markets, is one definition of the strategy encompassed by various embodiments of this disclosure. Promoting liquidity may be accomplished by delivering one or more of various core capabilities, including, but not limited to, for example:

Creating transparency in data: As mentioned earlier, data availability for these products is quite high; however, its timeliness, consistency, and formats are highly irregular and make this service very desirable to a wide constituency. Various embodiments and aspects of this disclosure service will consist of data aggregation (from servicers, trustees (including ourselves), rating agencies, issuers, and others), normalization and verification. With access to the data, in an organized database engine, we can provide individual position information, the collateral supporting that position, and the loan level detail supporting the collateral. This can then be aggregated and reported not only at the security level, but at the portfolio level, and even across portfolios. Thus allowing a clear look at exposure, correlation and other key risk metrics in detail.

Price Discovery & Performance Measurement: One of the key issues faced by the financial industry is that there is/was a general lack of due diligence, which can be addressed by data services provided by one or more embodiments of this disclosure. By providing independent pricing and risk assessment of either individual positions or entire portfolios, value added service can be provided. Various embodiments and aspects of this disclosure provide a method for a potential buyer to arrive at an appropriate valuation for an asset.

Global Electronic Auction platform (“Auction platform”): The need for buyers and sellers to have one place to come together to trade has been a hallmark of commerce since the earliest traders began business. As mentioned, earlier, the structured credit market has been fragmented since its development and has remained so. Conventionally, buyers and sellers have relied on investment banks and other finance companies to make markets in these securities. In this illiquid and changed market, however, this has caused a tremendous lack of confidence, “fire sale” prices, and an overall freeze in the secondary market. By creating a single auction platform, both buyers and sellers from around the world can go to one location for all of their critical needs, data, price discovery, and the ability to “point and click” to execute a trade. By requiring all participants to go through a rigorous registration process, all regulatory requirements can be met and confidence instilled in counterparties.

Various embodiments and aspects of this disclosure address market needs and requirements. For example, this disclosure enables better price discovery by providing a single marketplace to unite buyers and sellers, a centralized point of communication for all interested parties, publication of offers, bids and execution levels to facilitate price discovery, and provides a unique marketing tool for new funds and advisory businesses. Further, aspects of this disclosure provide the ability to assess risk to restore investor confidence by providing equal, low cost access to actual and normalized collateral level analysis, enabling required loan level analysis needed to assess future probability of collateral performance, providing an integrated loan and structure analysis tool, providing a transparent source code for bond models, and providing an open interface for investors to “plug-in” default and prepayment models.

In terms of supervision, embodiments and aspects of this disclosure enable evaluation how actual or predictive loan modifications affect security cash flows and enable the surveillance, regulatory reporting and evaluation of the effectiveness of stability programs.

Other features and advantages of various embodiments of this disclosure include eliminating the high cost barrier to entry, allowing interrogation of actual or predictive loan modifications on security cash flows. Further, various embodiments enables surveillance, regulatory reporting, and evaluation of the effectiveness of protocols and programs. Loan level historical data analysis and cash-flow scenarios are made available with the ability to dynamically group any collection of loans to perform detailed loan analysis. Further, aspects of embodiments of this disclosure provide a centralized and normalized data repository to facilitate risk related value decisions, and eliminates reliance on multiple data vendors.

### BRIEF DESCRIPTION OF THE DRAWINGS

Embodiments of the disclosure will now be described with reference to the accompanying drawings in which:

FIG. 1 provides a schematic block diagram that illustrates a trading system in which an auction platform of an embodiment of this disclosure is arranged;

FIG. 2 provides a simplified flow diagram that illustrates auction preparation, execution, and settlement functionality in an embodiment of this disclosure;

FIG. 3 provides functional block diagram of the auction platform of FIG. 1;

FIGS. 4A and 4B (collectively “FIG. 4”) illustrate a functional flow diagram of a registration and entitlement process for new auction participants in an embodiment;

FIGS. 5A and 5B (collectively “FIG. 5”) illustrate a functional flow diagram of a registration and entitlement process for existing auction participants and internal users in an embodiment;

FIG. 6 illustrates a functional flow diagram of a general navigation process after user login in an embodiment;

FIGS. 7A and 7B (collectively “FIG. 7”) illustrate a functional flow diagram of an auction process of an embodiment;

FIG. 8 illustrates a functional flow diagram of a continuation of the auction process of FIG. 7;

FIGS. 9A and 9B (collectively “FIG. 9”) illustrate a functional flow diagram of a seller's auction process after assets for sale have been posted to an associated “My Auctions” page in an embodiment;

FIG. 10 illustrates the continuation of the functional flow diagram of FIG. 9;

FIGS. 11A and 11B (collectively “FIG. 11”) illustrate a functional flow diagram of a settlement process after an auction has completed in an embodiment;

FIGS. 12A and 12B (collectively “FIG. 12”) illustrate a functional flow diagram of an inventory import process of an embodiment;

FIG. 13 illustrates a functional flow diagram of a reconciliation process of an embodiment;

FIG. 14 provides an exemplary screenshot of a participant home page for the auction platform of an embodiment;

FIG. 15 provides an exemplary screenshot of an administrative page that supports document management;

FIG. 16 provides an exemplary screenshot of a user's page that displays a portfolio summary;

FIG. 17 provides an exemplary screenshot of a user's page that displays a position detail for securities held by a participant;

FIG. 18 provides an exemplary screenshot of a seller's page in which an auction can be created;

FIG. 19 provides an exemplary screenshot of a seller's page that displays information relating to auctions in which the seller is involved;

FIG. 20 provides an exemplary screenshot of a buyer's page that displays information relating to auctions in which the buyer is involved;

FIG. 21 provides an exemplary screenshot of a buyer's page that displays information relating to a bid submission in an auction in which the buyer is involved;

FIG. 22 provides a state flow diagram for an auction process in accordance with an embodiment;

FIG. 23 provides a flow diagram related to an auction line item processed according to an embodiment;

FIG. 24 provides a flow diagram related to sealed bid auction process according to an embodiment;

FIG. 25 provides a flow diagram related to an English auction, single-price bidding process according to an embodiment; and

FIG. 26 provides a flow diagram related to an English auction, price-range bidding process according to an embodiment.

### DETAILED DESCRIPTION

The auction platform and method described herein may be implemented by a system that includes various computer processors and peripheral devices, such as memory devices, databases, and network interfaces, including the Internet.

An auction is a process of buying and selling goods or services by offering them up for bid, taking bids, and then selling the item to the highest bidder. In economic theory, an auction may refer to any mechanism or set of trading rules for exchange. There are several variations on the basic auction form, including time limits, minimum or maximum limits on bid prices, and special rules for determining the winning bidder(s) and sale price(s). Participants in an auction may or may not know the identities or actions of other participants. The seller usually pays a commission to the auctioneer or auction company based on a percentage of the final sale price.

There are several types of auctions in use, including the English auction, also known as an open ascending price auction. This type of auction is arguably the most common form of auction in use today. Participants bid openly against one another, with each subsequent bid higher than the previous bid. An auctioneer may announce prices, bidders may call out their bids themselves (or have a proxy call out a bid on their behalf), or bids may be submitted electronically with the highest current bid publicly displayed. In some cases a maximum bid might be left with the auctioneer, who may bid on behalf of the bidder according to the bidder's instructions. The auction ends when no participant is willing to bid further, at which point the highest bidder pays their bid. Alternatively, if the seller has set a minimum sale price in advance, i.e., the “reserve” price, and the final bid does not reach that price, the item remains unsold. Sometimes the auctioneer sets a minimum amount by which the next bid must exceed the current highest bid. The most significant distinguishing factor of this auction type is that the current highest bid is always available to potential bidders. At least two bidders are required.

A traditional “Dutch” auction, also known as an open descending price auction, the auctioneer begins with a high asking price which is lowered until some participant is willing to accept the auctioneer's price. The winning participant pays the last announced price. The Dutch auction is named for its best known example, the Dutch tulip auctions. The term “Dutch auction” is also sometimes used to describe online auctions where several identical goods are sold simultaneously to an equal number of high bidders.

In a “sealed first-price” auction, also known as a first-price sealed-bid auction (FPSB), all bidders simultaneously submit sealed bids so that no bidder knows the bid of any other participant. The highest bidder pays the price they submitted. This type of auction is distinct from the English auction, in that bidders can only submit one bid each. Furthermore, as bidders cannot see the bids of other participants, they cannot adjust their own bids accordingly. This kind of bid produces the same outcome as Dutch auction. Sealed first-price auctions are commonly used in tendering, particularly for government contracts and auctions for mining leases.

Various type of asset classes may be traded on the auction platform of this disclosure using a selected auction type described above. For example, residential mortgage-backed securities (RMBS) are a type of bond commonly issued in American security markets. They are a type of Mortgage-backed security which are backed by mortgages on residential rather than commercial real estate.

An asset-backed security (ABS) is a security whose value and income payments are derived from and collateralized (or “backed”) by a specified pool of underlying assets. The pool of assets is typically a group of small and illiquid assets that are unable to be sold individually. Pooling the assets into financial instruments allows them to be sold to general investors, a process called securitization, and allows the risk of investing in the underlying assets to be diversified because each security will represent a fraction of the total value of the diverse pool of underlying assets. The pools of underlying assets can include common payments from credit cards, auto loans, and mortgage loans, to esoteric cash flows from aircraft leases, royalty payments and movie revenues.

Commercial mortgage-backed securities (CMBS) are a type of bond commonly issued in American security markets. They are a type of mortgage-backed security backed by mortgages on commercial rather than residential real estate. CMBS issues are usually structured as multiple tranches, similar to CMOs, rather than typical residential “passthroughs.”

Collateralized debt obligations (CDOs) are a type of structured asset-backed security (ABS) whose value and payments are derived from a portfolio of fixed-income underlying assets. CDOs are assigned different risk classes, or tranches, whereby “senior” tranches are considered the safest securities. Interest and principal payments are made in order of seniority, so that junior tranches offer higher coupon payments (and interest rates) or lower prices to compensate for additional default risk. Many CDOs are valued on a mark-to-market basis, and thus have experienced substantial write-downs on the balance sheet as their market value has collapsed.

A collateralized mortgage obligation (CMO) is a financial debt vehicle that was first created in June 1983 by the investment banks Salomon Brothers and First Boston for Freddie Mac. Legally, a CMO is a special purpose entity that is wholly separate from the institution(s) that create it. The entity is the legal owner of a set of mortgages, called a pool. Investors in a CMO buy bonds issued by the entity, and receive payments according to a defined set of rules. The mortgages themselves are called the collateral, the bonds are called tranches (also called classes), and the set of rules that dictates how money received from the collateral will be distributed is called the structure. The legal entity, collateral, and structure are collectively referred to as “the deal”. Investors in CMOs include banks, hedge funds, insurance companies, pension funds, mutual funds, government agencies, and most recently central banks A CMO is essentially a way to create many different kinds of bonds from the same mortgage loan so as to please many different kinds of investors. A group of mortgages could create different classes of bonds with characteristics that allow investors to choose between interest-only (10) or principal-only (PO) bonds to better manage their sensitivity to interest rates, and can be used to manage and offset the interest rate-related price changes in other investments.

An American Depositary Receipt (ADR) represents ownership in the shares of a non-U.S. company and trades in U.S. financial markets. The stock of many non-US companies trade on US stock exchanges through the use of ADRs. ADRs enable U.S. investors to buy shares in foreign companies without the hazards or inconveniences of cross-border & cross-currency transactions. ADRs carry prices in US dollars, pay dividends in US dollars, and can be traded like the shares of US-based companies.

An auction rate security (ARS) typically refers to a debt instrument (corporate or municipal bonds) with a long-term nominal maturity for which the interest rate is regularly reset through a Dutch auction. Since February 2008, most such auctions have failed, and the auction market has been largely frozen. In late 2008, investment banks that had marketed and distributed auction rate securities agreed to repurchase most of them at par. The interest rate on ARS is determined through a Dutch auction process. The total number of shares available to auction at any given period is determined by the number of existing bond holders who wish to sell or hold bonds only at a minimum yield. Each bid and order size is ranked from lowest to highest minimum bid rate. The lowest bid rate at which all the shares can be sold at par establishes the interest rate, otherwise known as the “clearing rate”. This rate is paid on the entire issue for the upcoming period. Investors who bid a minimum rate above the clearing rate receive no bonds, while those whose minimum bid rates were at or below the clearing rate receive the clearing rate for the next period.

A warrant is a security that entitles the holder to buy stock of the company that issued it at a specified price, which is usually higher than the stock price at time of issue. Warrants are frequently attached to bonds or preferred stock as a sweetener, allowing the issuer to pay lower interest rates or dividends. They can be used to enhance the yield of the bond, and make them more attractive to potential buyers. Warrants can also be used in private equity deals. Frequently, these warrants are detachable, and can be sold independently of the bond or stock. Warrants are actively traded in some financial markets such as Deutsche Borse and Hong Kong.

Preferred stock, also called preferred shares or preference shares, is typically a “higher ranking” stock than common stock, and its terms are negotiated between the corporation and the investor. Preferred stock usually carries no voting rights, but may carry priority over common stock in the payment of dividends and upon liquidation. Preferred stock may carry a dividend that is paid out prior to any dividends being paid to common stock holders. Preferred stock may have a convertibility feature into common stock. Preferred stockholders will be paid out in assets before common stockholders and after debt holders in bankruptcy. Terms of the preferred stock are stated in a “Certificate of Designation”.

“Whole loan pools” involve whole loans that are usually larger in size than the maximum amount allowed within GNMA, FNMA and, FHLMC's standards. Private entities pool whole-loans together with credit enhancements to create whole loan CMOs. Credit enhancements ensure investors receive timely interest payments.

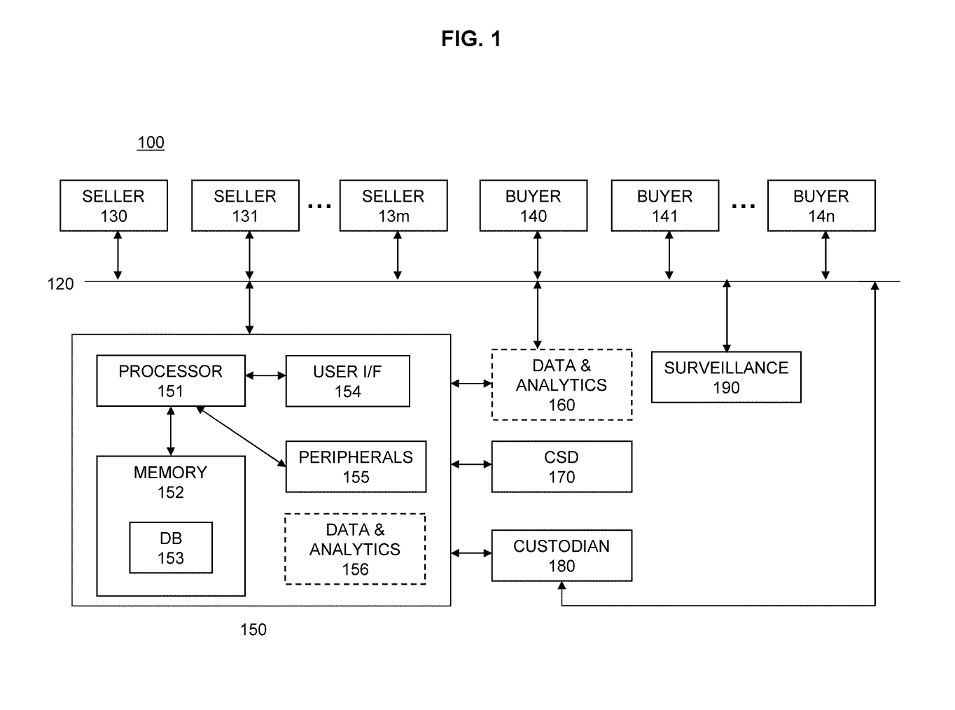

Turning now to the drawings, FIG. 1 illustrates a schematic block diagram of trading system 100 in which a plurality of sellers 130, 131, . . . , 13m are connected electronically to electronic network 120 in a known manner through appropriate computer network interfaces using, for example, the Internet and TCP/IP communication protocols, or through a private network. A plurality of buyers 140, 141, . . . , 14n may also be connected to network 120. Precautions necessary to ensure the privacy and security of electronic data exchanged between parties may be taken in any number of known ways.

Auction platform 150 may include processor 151, memory device(s) 152, which may contain database 153, e.g., a structured database. Processor 151 may be part of a personal computer, computer workstation, or mainframe computer, and may also represent multi-processor configurations useful, with proper programming, to improve processing speed.

Memory device(s) 152 may be, for example, known types of solid-state memory such as dynamic random access memory (DRAM) that stores information, including information formatted for storage in structured database 153. Memory 152 may be backed up by known redundant storage media, e.g., tape backup (not shown). Structured database 153 may be implemented, for example, as a Structured Query Language (SQL) database or other type of known database format that is compatible or desired to be used with the particular software programming approach used to implement the trade platform. Structured database 153 may be configured to store information including, for example, information relating to multiple auction participants.

User interface 154 may be implemented by any number of conventional input/output and/or display devices, e.g., mouse, keyboard, touch screen, etc. Peripherals 155 represent other conventional computer peripheral devices such as displays, printers, additional and/or mass storage devices, and scanner, for example.

Auction platform 150 may also include data and analytics tool 156 which is a part of auction platform 150, or auction platform 150 may interface with data and analytics tool 160 over a private network, or over network 120. The dashed lines around tools 156 and 160 denote two alternative or complementary implementations. In the case of data and analytics tool 160 being external to auction platform 150, data and analytics tool 160 may be a third party tool such as that provided by Portsmouth Financial Services. In either implementation, either of data and analytics tool 156 or 160 represent a significant improvement over conventional approaches by providing direct, integrated access to the data and analytics tool.

Auction platform 150 may also electronically interface with Central Securities Depository (CSD) 170 via a private network/communications channel, or over network 120 (not shown). CSD 170 may be any one of a number of international securities clearing houses, e.g., the DTC, Euro Clear, or Clearstream, responsible for clearing and settlement of millions of dollars of securities trades a day.

The Depository Trust & Clearing Corporation (DTCC), based primarily in New York City, is the world's largest post-trade financial services company. It was set up to provide an efficient and safe way for buyers and sellers of securities to make their exchange, and thus “clear and settle” transactions. It also provides custody of securities. User-owned and directed, it automates, centralizes, standardizes, and streamlines processes that are critical to the safety and soundness of the world's capital markets. Through its subsidiaries, DTCC provides clearance, settlement, and information services for equities, corporate and municipal bonds, unit investment trusts, government and mortgage-backed securities, money market instruments, and over-the-counter derivatives. DTCC is also a leading processor of mutual funds and insurance transactions, linking funds and carriers with their distribution networks. DTCC's DTC depository provides custody and asset servicing for 3.5 million securities issues, comprised mostly of stocks and bonds, from the United States and 110 other countries and territories, valued at $40 trillion, more than any other depository in the world. In 2007, DTCC settled the vast majority of securities transactions in the United States, more than $1.86 quadrillion in value. DTCC has operating facilities in New York City, and at multiple locations in and outside the U.S. CSD 170 may interface with one or more custodians 180 which represent any number of custodial banks engaged in providing services related to securitized investor holdings, e.g., the Bank of New York Mellon.

Surveillance module 190 may perform a marketplace surveillance function that performs oversight of trading activity, and may include regulatory agencies, risk officers or systemic risk regulators that may be required under various scenarios to approve trades of financial instruments under its control. For example, in the case of the Troubled Asset Relief Program (TARP), the FDIC or Treasury Department may have a stake in approving or regulating the sale of certain assets.

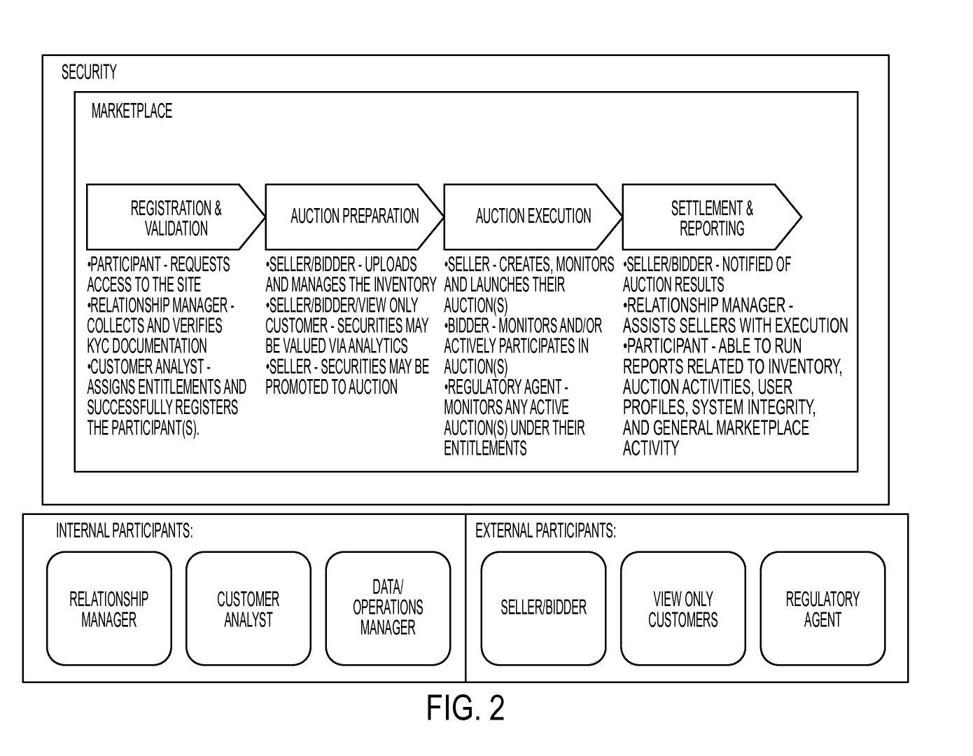

FIG. 2 provides a simplified flow diagram that illustrates auction preparation, execution, and settlement functionality in an embodiment of this disclosure. In the registration and validation phase, a participant requests access to the auction site. A relationship manager collects and verifies “know your customer” (KYC) required information from the participant. A customer service representative (CSR) or customer analyst assigns various entitlements based upon the type of participation requested or available, e.g., a seller, bidder, “view only” customer, or regulator, and completes participant registration. The CSR may be a primary resource for assisting customers with account verification, auction preparation, report generation, custody services, and provides a response to customer inquiries. Subsets of this role will perform KYC information gathering and verification as well as oversight of data governance and integrity. The CSR may also function as a help desk resource who will resolve technical issues that arise during login or general navigation.

In the auction preparation phase, a seller uploads their inventory to the auction platform, and manages the inventory. Each of the various types of participants may determine a valuation for various securities offered on the auction platform by the use of an analytics tool using cash flow modeling, for example. Further, a seller may “promote” their inventory of financial instruments to auction.

In the auction execution phase, sellers may create, monitor, and launch their auction(s). Bidders may monitor and/or actively participates in auction(s). A regulatory agent may monitor any active auction(s) under their entitlements.

In the settlement and reporting phase, the seller and bidder may be notified of auction results, and a relationship manager can offer assistance to the participants with execution over network 120. Participants are able to use the functionality to run reports related to inventory, auction activities, user profiles, system integrity, and general marketplace activity.

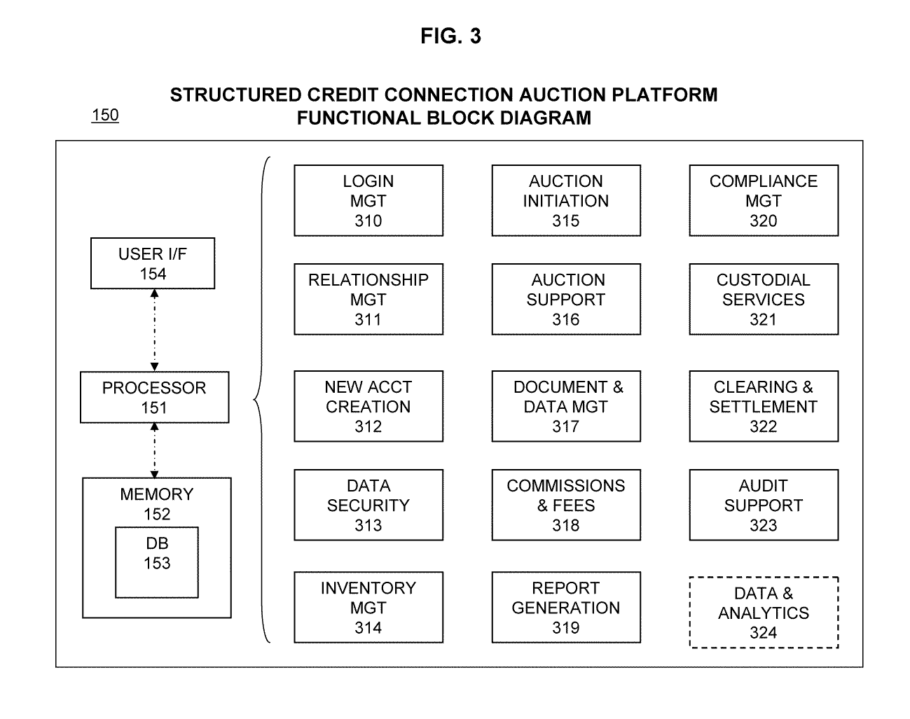

FIG. 3 provides functional block diagram of auction platform 150 in FIG. 1. The functionality carried out by auction platform 150 may be carried out by properly programming processor 151 with appropriate software. The various types of functionality are represented by the functional modules in FIG. 3 and included inventory management, an alert system, delivery of notices, and auction functionality—creation, surveillance, modification, termination and bidding. In addition, a document management system stores documents assigned IDs with references to physical documents available for auction-related security analysis. Access to auction platform 150 may be provides through an Internet based interface for clients, as well as for platform management staff with minimal reporting and auction participation capability. A participant management system may include a new user registration form, a database of user, group and organization level information and entitlements, and a database of user investment profiles and preferences.

For example, login management module 310 may be configured to carry out various tasks required to granting access to participants, e.g., sellers, buyers, or regulatory agents. Relationship management module 311 may be configured to carry out customer service functions which enhance customers' satisfaction and levels of service. New account creation module 312 may be configured to carry out functions related to establishing new auction account or non-bidder/seller entitlements. Data security module 313 may be configured to provide the necessary levels of security, for example, by assigning login credentials and related password protections for data resident on auction platform 150. Inventory management module 314 may be configured to support sellers when inventory is uploaded and/or removed. Auction initiation module 315 may be configured to establish various types of auctions, and the parameters associated with platform-supported auctions. Auction support module 316 may be configured to provide support for an ongoing auction, such as qualifying sellers, and causing the sellers' various positions offered for auction to be “locked” or “escrowed” to avoid premature withdrawal by the seller before the auction has completed. Document and data management module 317 may be configured to manage information and access links related to documents associated with various financial instruments offered for auction. Commissions and fees module 318 may be configured to calculate and process various fees and/or commissions paid or payable in connection with the auction, offering for auction, or clearing and settlement. Report generation module 319 may be configured to provide various reports, e.g., position reports, change of positions, etc. for users of auction platform 150. Reporting on inventory is possible in a variety of formats to allow for reconciliation. For example, aggregate reporting of assets in inventory and in an auction may be sortable by CUSIP, and spreadsheet download of aggregate data may also be implemented.

Compliance management module 320 may be configured to ensure compliance with any pertinent regulatory requirements, e.g., required reporting to government agencies, and “know your customer” requirements. Custodial services module 321 may be configured to monitor and/or direct custody of assets being auctioned, e.g., by directing that financial instruments being auctioned be escrowed or otherwise “locked” from trading until the auction is complete. Clearing and settlement support module 322 may be configured to provide services related to clearing and settlement of auction trades carried out by auction platform 150. Audit support module 323 may be configured to audit the various services provided by auction platform 150, and to provide a record of activities that cause various data records stored in database 153 to be added, changed, or deleted, for example. Data and analytics module 324 may either be configured to monitor and control access to external tool 160, e.g., the Portsmouth Financial Services analytic tool that provides access to cash flow monitoring software to allow users to analyze and assess asset backed securities and loan portfolios so as to come to an understanding of potential valuation of the financial instrument. Alternatively, data and analytics module 324 may be configured to allow processing and data management required for cash flow modeling and risk assessment internally to auction platform 150, for example.

Table 1 below provides a summary of various functions that may be performed in one or more embodiments by auction platform 150.

TABLE 1

| Function | Description |
|---|---|
| Login and | This covers the function and use of the application login and home pages. |
| Home | The login page allows existing users to log in to the app, and has a link to the company registration |
| Page | page. It may also display marketing information. |
| | The home page displays the main user menu, and may also display news, alerts, etc. |
| Access | This describes the link to the Portsmouth analytics tool, and how contextual information is passed to |
| Security | that tool (if that is possible). |
| Analytics | |
| Enter | This allows a company to request to become a participant in our system. The form basically collects |
| Registration | contact information which a CSR will use to initiate the process of creating the business |
| Request | relationship. |
| Manage | This set of functions allows CSR's to create and maintain participating companies. It includes: |
| Participants | a CSR queue listing new and pending registration requests. |
| | CRUD for companies. |
| | CRUD for groups within companies. |
| | CRUD for contacts within companies and groups. |
| Manage | This area covers DSA functions: creating and maintaining users and their entitlements. It includes: |
| Users | CRUD for users, including assignment of roles. |
| | CRUD for user roles. |
| | Assignment of portfolio rights to users. In Phase 1, this may function may not be given to clients. |
| Upload | This allows a trader to upload positions into his portfolios. It also covers the handling of exceptions |
| Inventory | in the upload process. |
| Manage | This covers the functions in My World, involving the creation and maintenance of portfolios and the |
| Inventory | positions held in them. It includes: |
| | CRUD for portfolios. |
| | Possibly: granting of rights for a portfolio to other users. |
| | CRUD for positions within a portfolio. |
| Maintain | This covers the import and maintenance of security information. It includes: |
| Security | Import of security information from the bank SMDB. |
| Master | CRUD, or possibly only RUD, for security data. |
| Data | Possibly: a CSR queue of assets that have been uploaded that are not saved in our SMDB. |
| | Possibly: a CSR approval queue for uploaded documents. |
| Maintain | This covers the creation of auctions and management of their parameters. It includes: |
| Auctions | Creating auctions and setting their parameters. |
| | Including assets in an auction and adjusting the position in the seller's portfolio. |
| | Uploading documents for securities included in auctions. |
| | Sellers submitting, modifying, releasing, extending, and canceling auctions. |
| Administer | This covers the management of auctions by CSR's. It includes: |
| Auction | A CSR queue listing submitted, pending, current, and future auctions. |
| Queue | The selection of submitted auctions by CSR's for the purposes of validation. |
| | CSR's verifying, rejecting, completing, and canceling auctions, and adjusting positions in the |
| | seller's portfolios accordingly. |
| Display | This covers the My Auctions and Current Auctions pages, and deals with the display of current and |
| Auctions | future auctions. It includes: |
| | Searching, listing, and displaying auction data in various ways, including bidding history and |
| | auction-related documents. |
| | The Associated Auctions “widget”. |
| | Watch lists. |
| Execute | This describes the actual processing of auctions. It includes: |
| Auction | The types of auctions supported (sealed bid vs. English, fixed price vs. maximum price and |
| | increments) and how they are processed. |
| | The automatic starting, ending, and canceling by the application based on deadlines. |
| | The notification of interested parties according to event. |
| Submit | This area covers the submission, processing, and modification of bids. |
| Bid | |
| Alerts & | This covers the displaying of alerts and notification on screen and by email, including: |
| Notifications | What kinds of alerts and/or notifications are produced by what events. |
| | How alerts and notifications are delivered to different users. |
| Billing | This describes what kind of billing information is produced by the app and how it is delivered to |
| | FiRRe. |
| Reports | This describes the different reports the app produces and the forms in which they can be generated. |
| Auditing | This covers the information that must be recorded about system events for auditing purposes. |

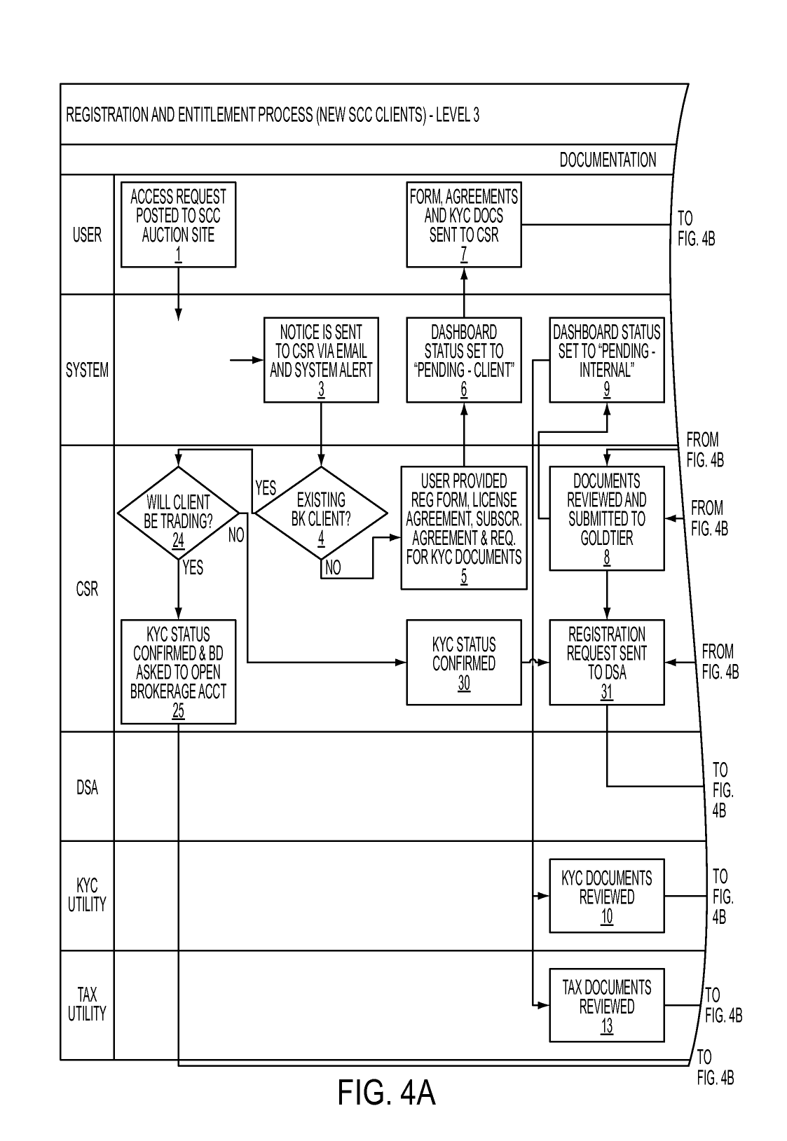

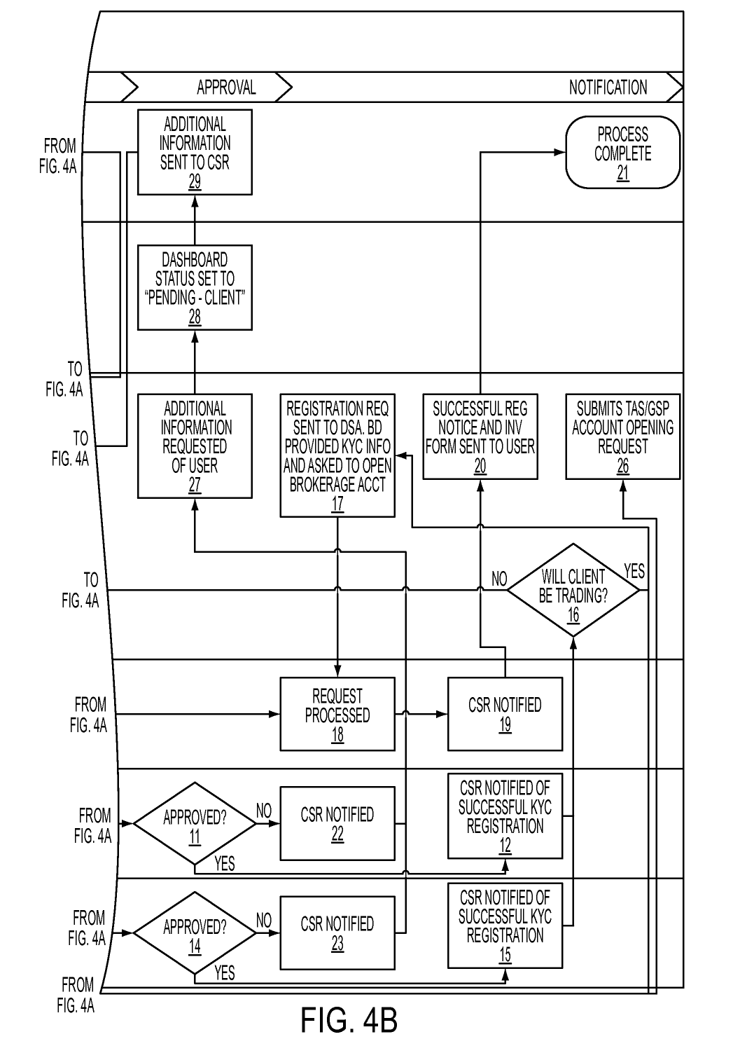

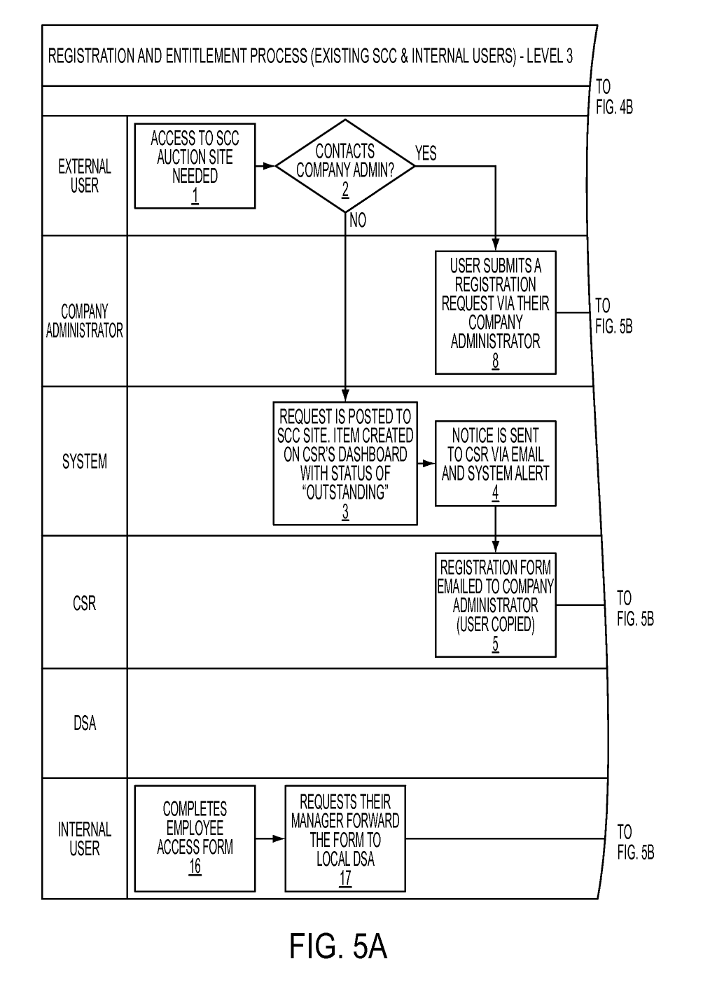

FIG. 4 illustrates a functional flow diagram of a registration and security entitlement process for new auction participants. Clients with no relationship with the auction platform manager, for example, the “Structured Credit Connection” (SCC) platform to be offered by The Bank of New York Mellon, will submit a registration request via a portal to the auction platform. The auction portal may be accessible via the Internet or other network. The Customer Service Representative (CSR) then provides the user with all forms, agreements and a list of required KYC documentation required to obtain access to the SCC site. The CSR receives, validates and submits the completed documentation to a Tax Utility and a KYC Utility (not shown). Once approval has been received, the registration form is submitted to a Data Security Administrator (DSA), a resource who will interface with the Help Desk and the CSR in order to provide account access and entitlements during the registration processes, and removal of entitlements at termination of an account. The DSA functions to create the user's account and assigns all applicable entitlements. If the user will be trading, custody accounts are opened and KYC approval is provided to the platform manager, along with a request to open a brokerage account for the user. The user receives confirmation of a successful registration via email with login name and temporary password. This process may be monitored via a “dashboard” application on the user's home page.

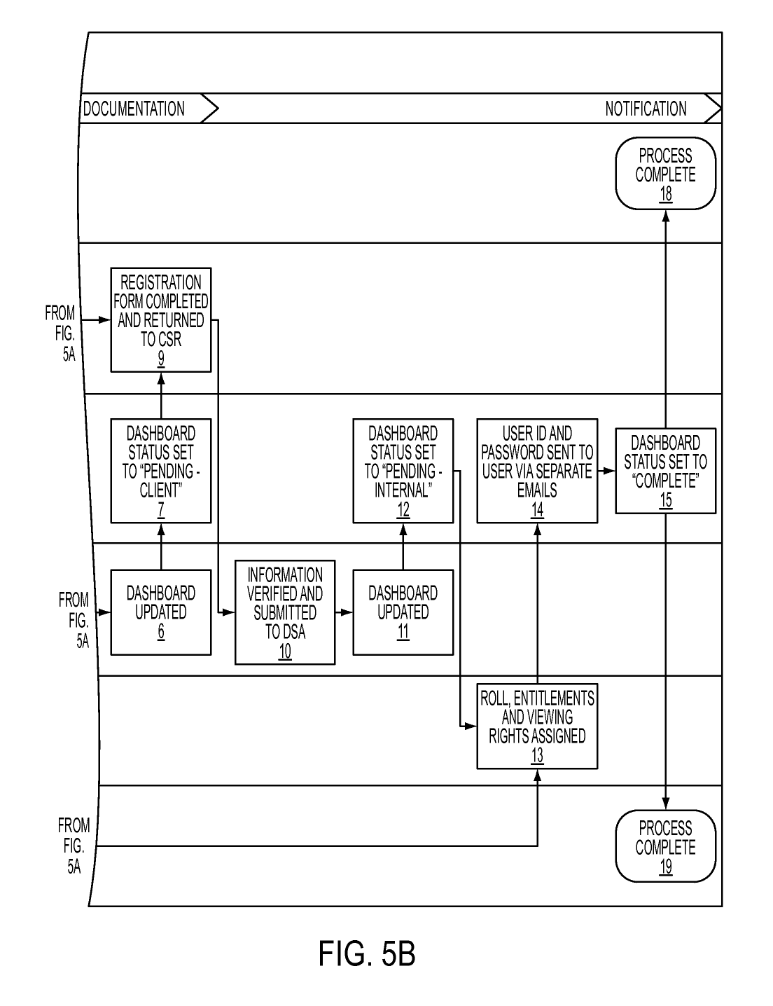

FIG. 5 illustrates a functional flow diagram of a registration and entitlement process for existing auction participants and internal users. Clients with an existing relationship with the platform manager can also submit a registration request via the portal or, alternatively, they may communicate their request, via their company administrator, to the CSR. The registration form is submitted to the DSA. The user receives confirmation of a successful registration via email with login name and temporary password. This process may also be monitored via a dashboard application within a portal page. Internal users will gain access by submitting the registration form, along with the appropriate managerial approvals, directly to their DSA. Internal users interact via the same GUI with additional transaction entry privileges. “Read-Only” entitlements may be granted to a non-trade eligible resource who will gather information related to the site, and may include analysts, research groups, news groups and rating agencies. “Read-Write” entitlements may be granted to a non-trade eligible resource who will gather information related to the site, and may include analysts, research groups, news groups and rating agencies. This resource will be able to import and manage inventory. “Trader” entitlements may be granted to a resource who will sell securities from their inventory or purchase securities, e.g., a seller or buyer.

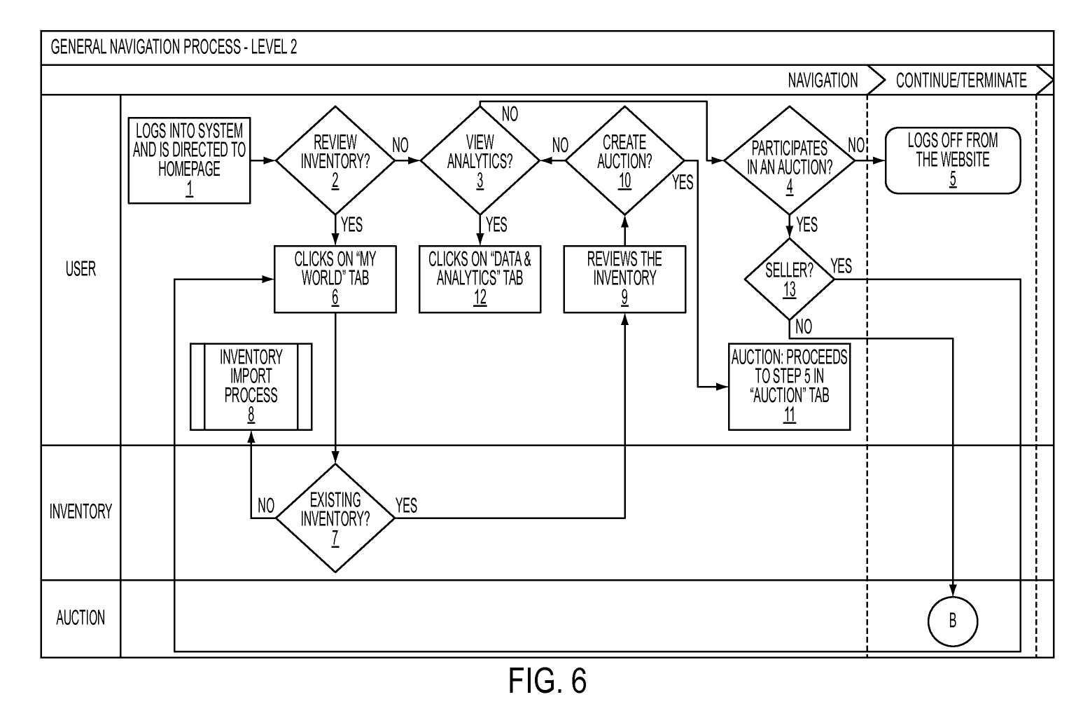

FIG. 6 illustrates a functional flow diagram of a general navigation process after user login. Following the registration process above, the user logs into platform 150 via, for example, a “My World” homepage presented with a number of navigational options. These options include, inventory management, data and analytics and auction participation.

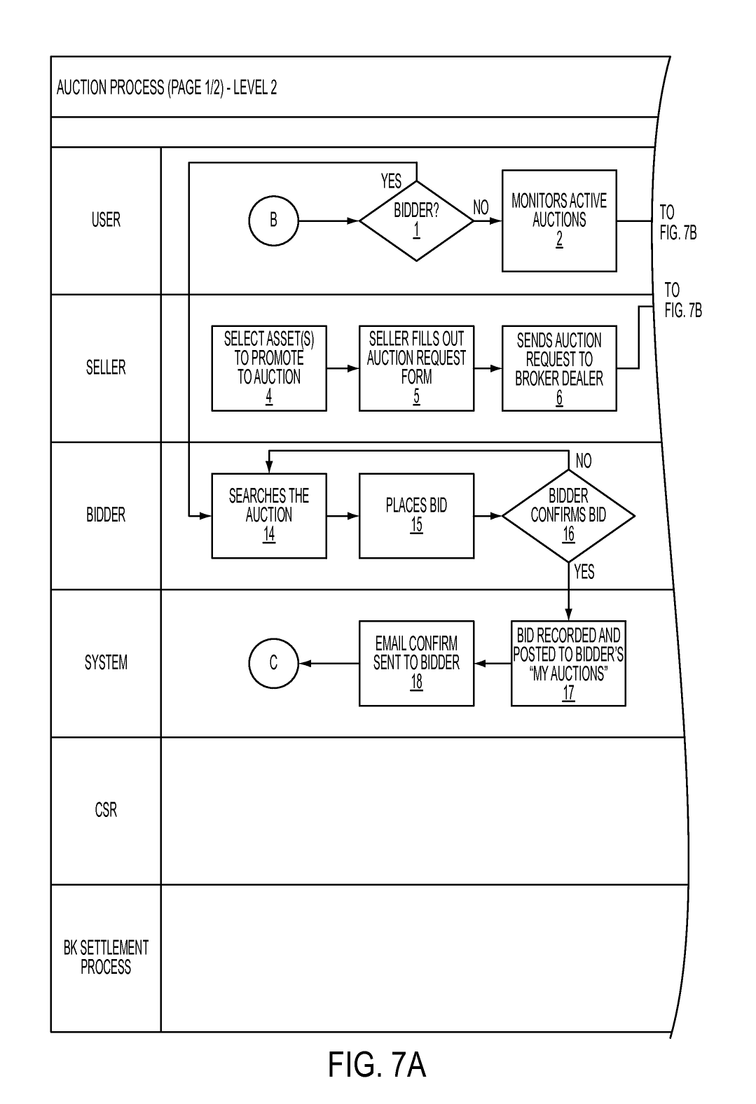

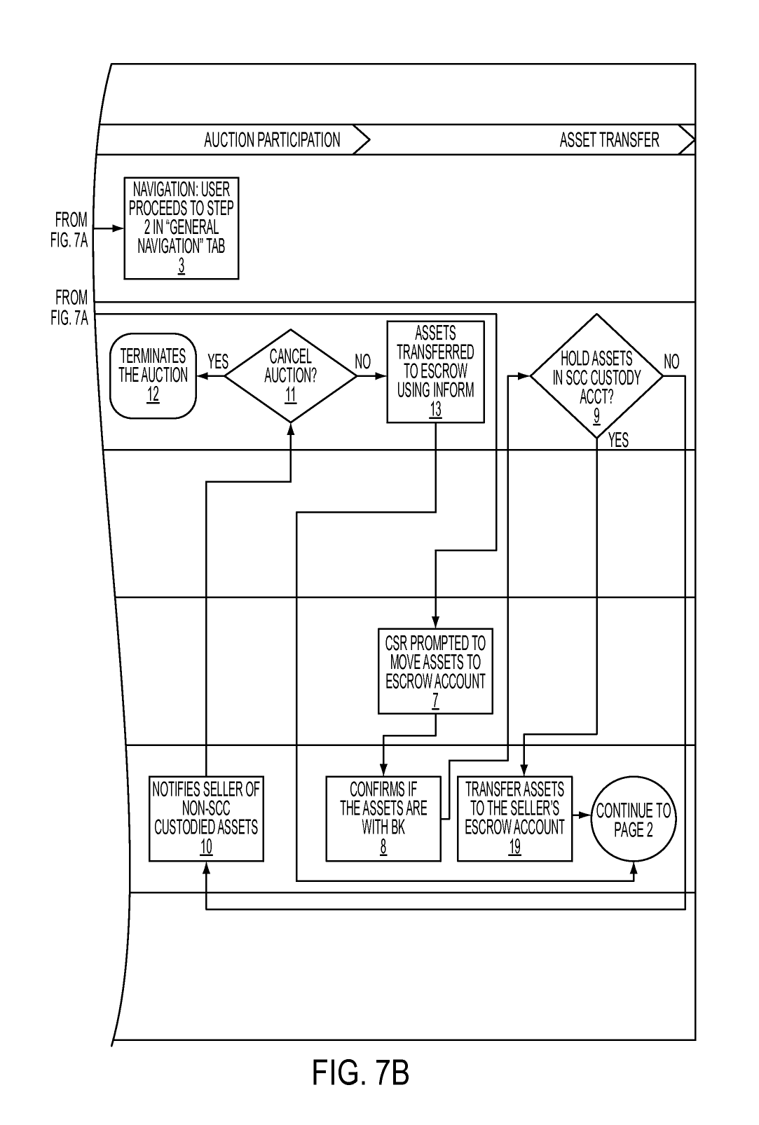

FIG. 7 illustrates a functional flow diagram of an auction process in which a user decides if they want to participate in the auction site as a bidder or seller. A seller is able to promote assets from their inventory to auction, send auction requests to the CSR, and cancel the auction. A bidder is able to search the portal and place a bid. Once the seller sends an auction request to the CSR, the CSR confirms if the seller holds the assets with the platform manager. The seller may sends transfer directions to the CSR to transfer the assets to the holding account.

If the assets are not held by the platform manager, the CSR informs the seller. The seller decides to either cancel the auction or deliver the assets to their escrow account.

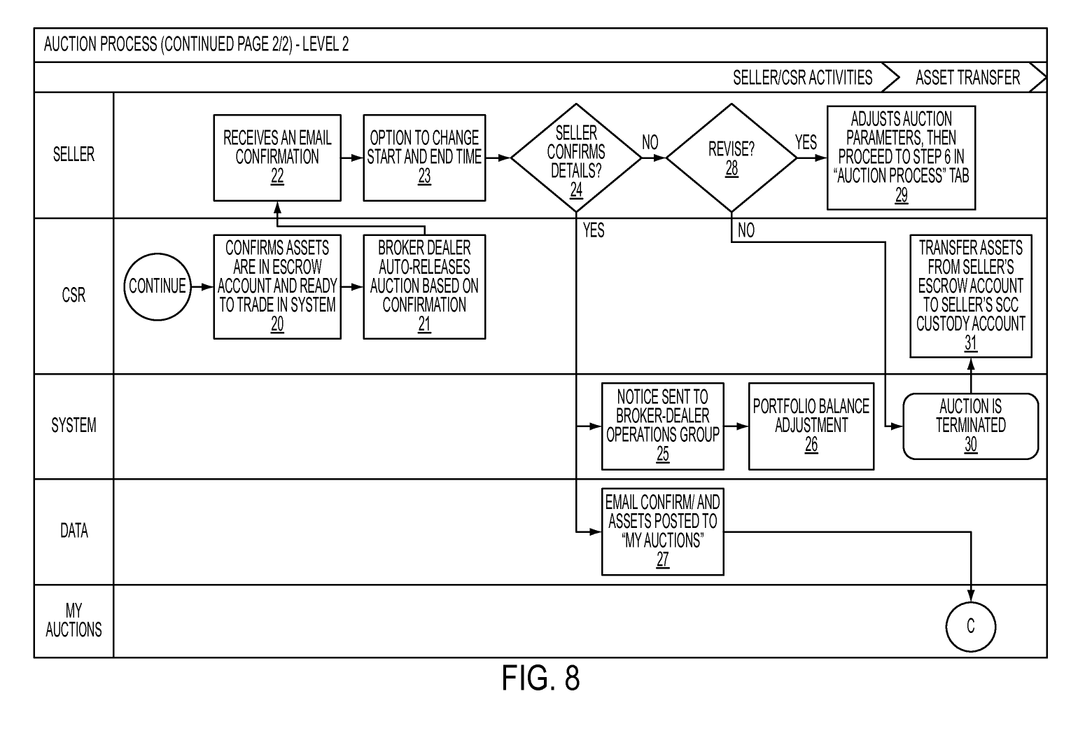

In FIG. 8, the auction process of FIG. 7 is continued. Once the seller transfers the assets to their escrow account, the CSR releases the auction and the system generates the final confirmation request. During this time, the seller is able to change the start and end time, and to revise the auction. The auction terminates if required revisions haven't been made by the seller, and the assets are transferred from the escrow account to the seller's custody account. Otherwise, the seller adjusts the auction parameters and sends an auction request to the CSR to process the auction request. Email confirmation may be sent by the auction platform confirming that the assets have been posted to the participant's “My Auctions”.

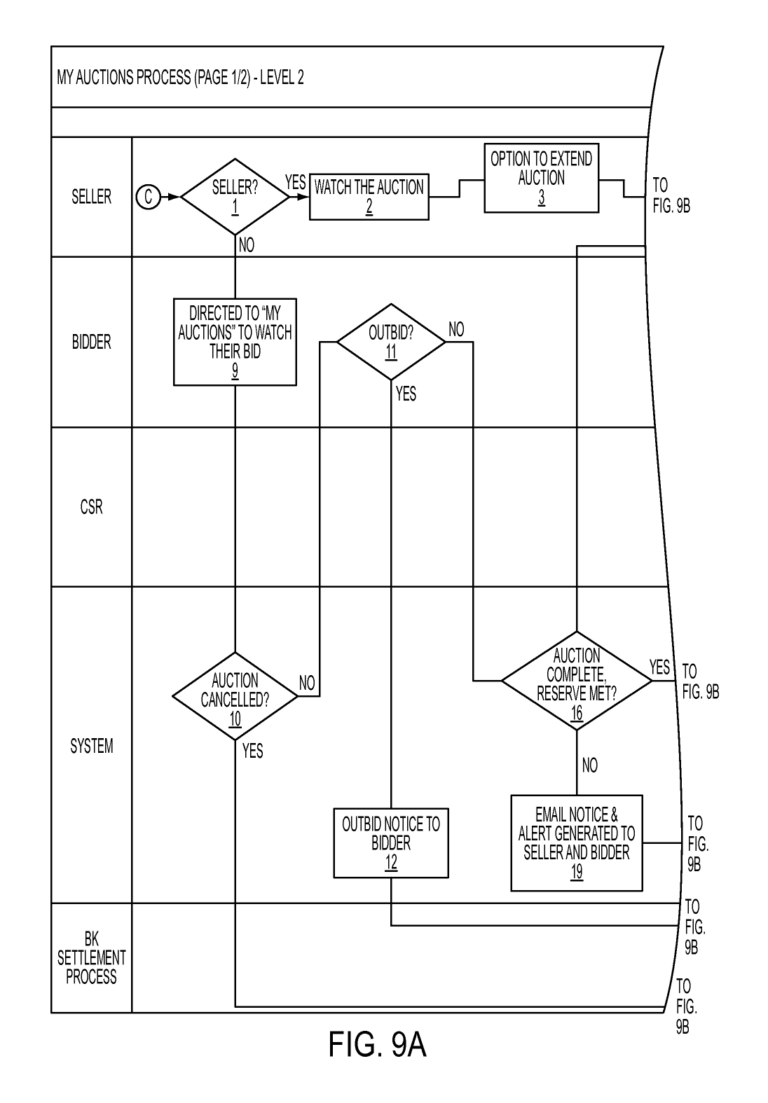

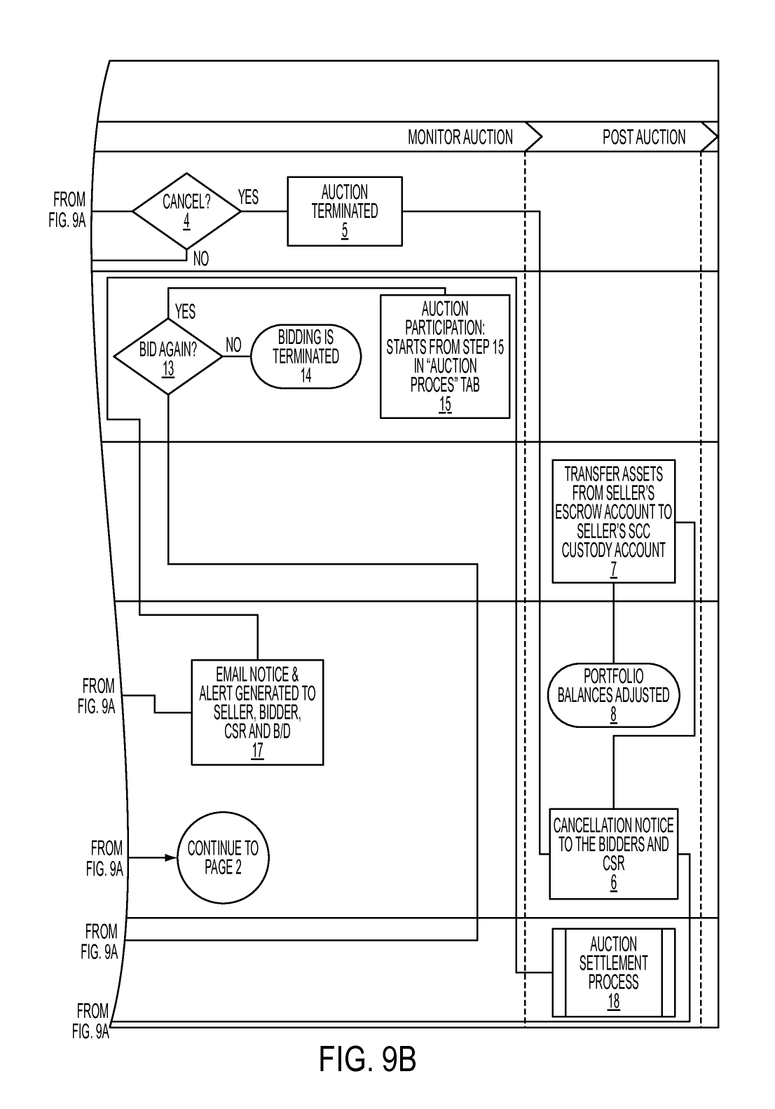

FIG. 9 illustrates a functional flow diagram of a seller's auction process (“My Auction”) after assets for sale have been posted to an associated “My Auctions” page. After the seller posts their assets to “My Auctions” page, they have options in this page to watch the auction, extend the auction, or cancel the auction. If the seller cancels the auction, the system carries out portfolio adjustments to the seller's account and sends out a note to the bidder that the auction has been canceled. The bidder in “My Auctions” page can bid and watch their bid. If the bidder was outbid, the confirmation notice will be sent to them and they have an option to bid again. If the bidder won the auction, the system notice is generated to seller, bidder, CSR, and custody system. If the auction is complete and no reserve has been met, a system notice is generated to the seller and the leading bidder.

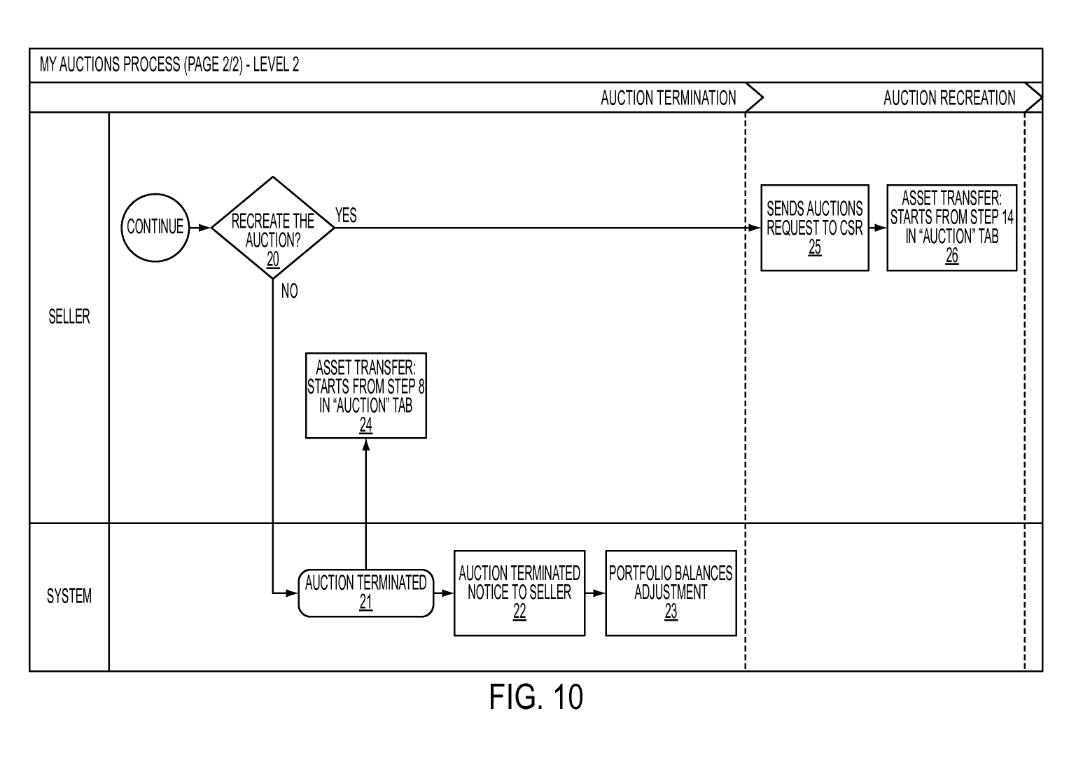

In FIG. 10, once it has been established that the reserve price has not been met, the seller has the option to recreate or terminate the auction.

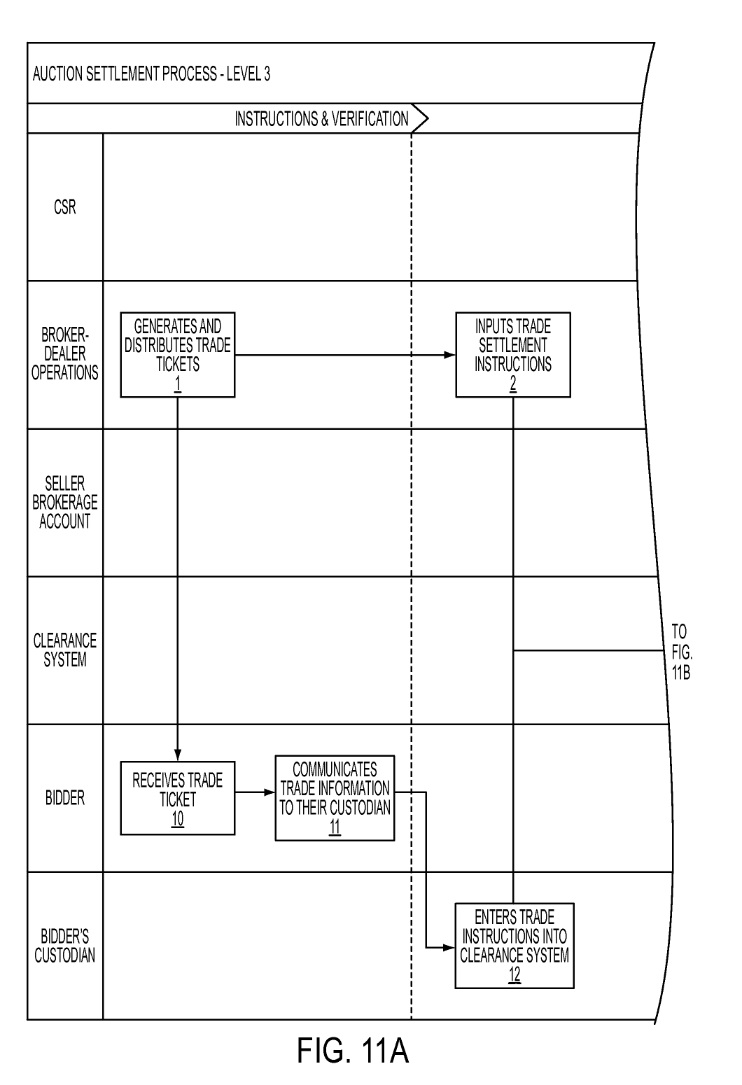

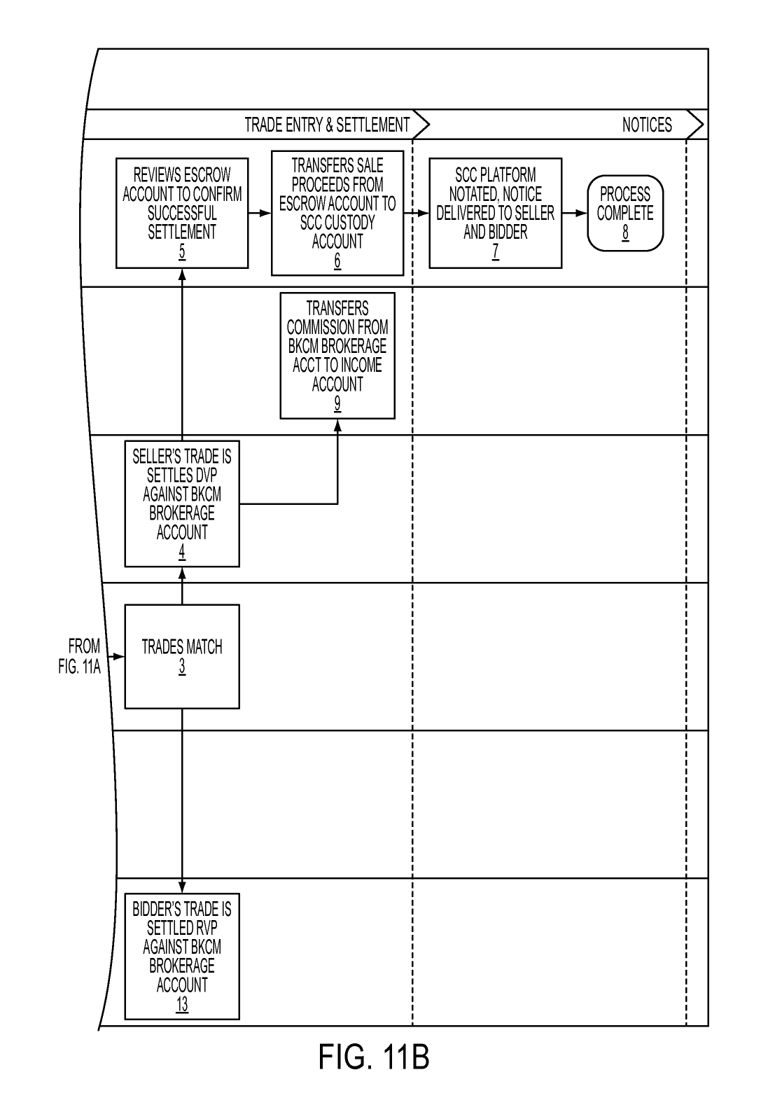

FIG. 11 illustrates a functional flow diagram of a settlement process after an auction has completed. Settlement proceeds through functions carried out, at least in part, by settlement module 322. In this process auction platform 150 may provide the bidder a trade ticket. Auctioned assets are transferred from the seller's escrow account to their brokerage account. Platform 150 enters the trade information into the clearing system. When the trade information matches the information posted by the bidder, the trade settles and the cash proceeds are deposited into the seller's brokerage account. The CSR monitors the seller's brokerage account to confirm successful settlement, and then transfers the cash to the seller's custody account. Following successful settlement, the CSR indicates the process has been complete by changing the status of the security, as listed in its auction, to “sale complete.”

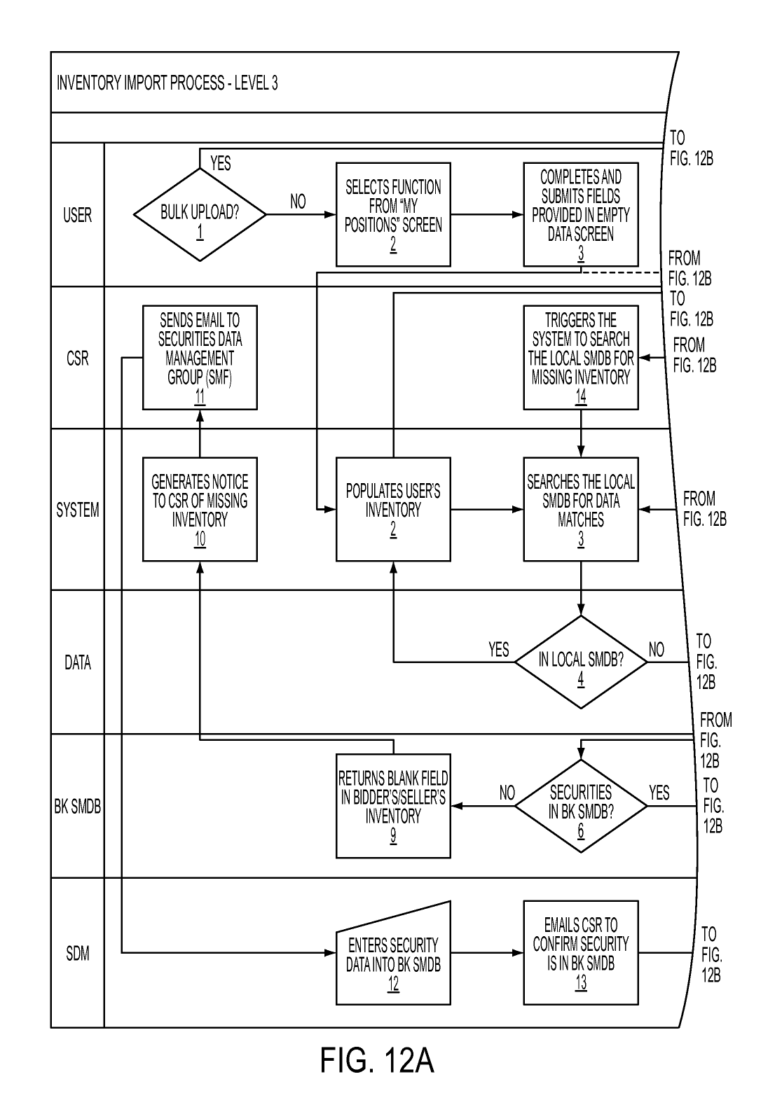

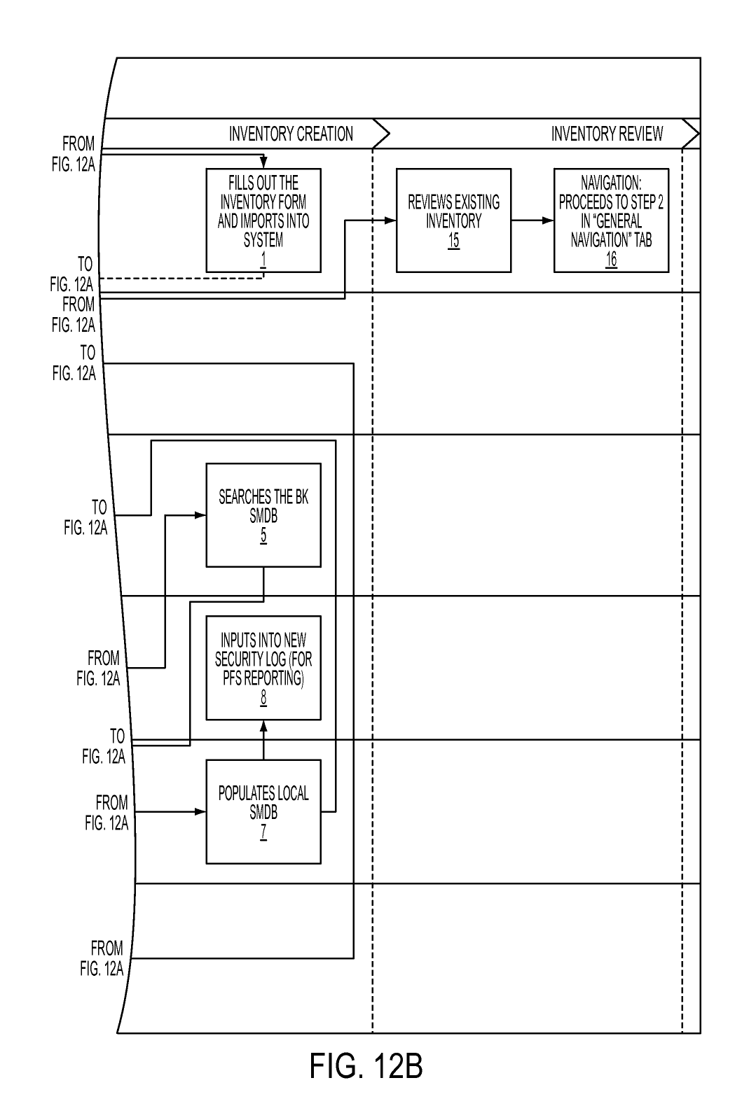

FIG. 12 illustrates a functional flow diagram of an inventory import process in which users with sufficient entitlements may create portfolios of inventory by either bulk loading securities using an online inventory form upload, or by manually entering individual securities via a function available in their “My Positions” screen. Upon submission of the security information by the user, the system populates the user's inventory and searches a local Securities Master Database (SMDB) for data matches. If the data is missing from the local SMDB, the system starts searching the platform manager's SMDB, and populates the local SMDB and the bidder's/seller's inventory. If the platform manager's SMDB comes back with no match, the CSR sends a message to a Securities Data Management group requesting security entry into the platform manager's SMDB. After Securities Data Management group enters the security information into the platform manager's SMDB, the local SMDB is populated with missing inventory. Each time a new security is added to the local SMDB, it may also be added to a periodic report available to the data analytics provider

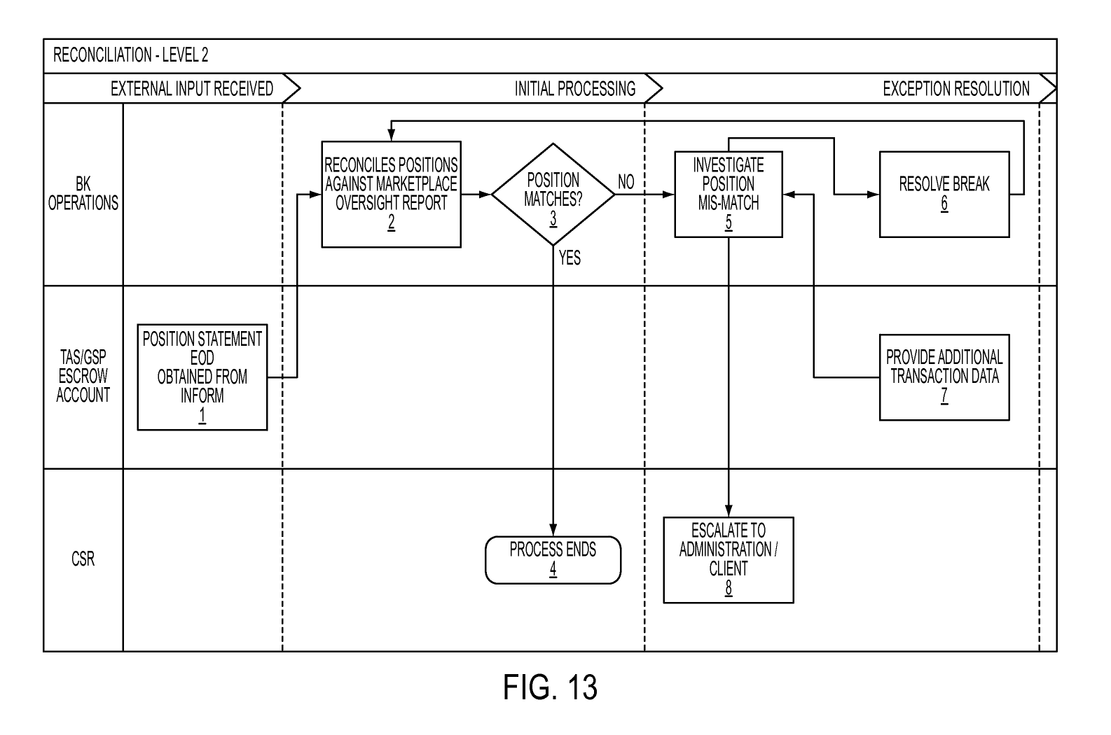

FIG. 13 illustrates a functional flow diagram of a reconciliation process in which an escrow account can be reconciled by comparing the information within the platform manager's system to the information within a Marketplace Oversight Report generated by report generation module 319. If the positions do not match, the exception will be flagged, investigated, and resolved. Once the positions match or the exceptions have been explained, the process is complete and will be documented and archived.

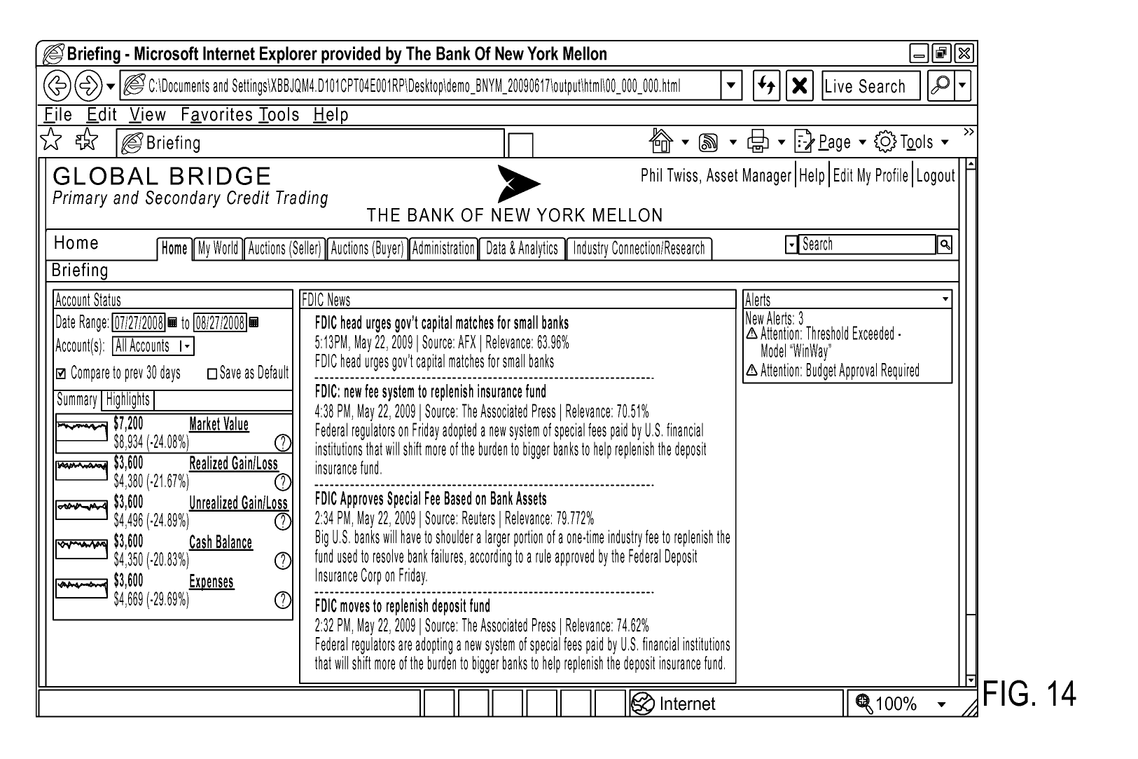

FIGS. 14-21 provide various exemplary screenshots which are intended to generally convey the “look and feel” of the graphical user interface (GUI) provided to users of auction platform 150. These screens are not necessarily intended to convey precise information or formats of information available through auction platform 150, but are merely representative of the types of displays and information presented therein that may be made available to system users.

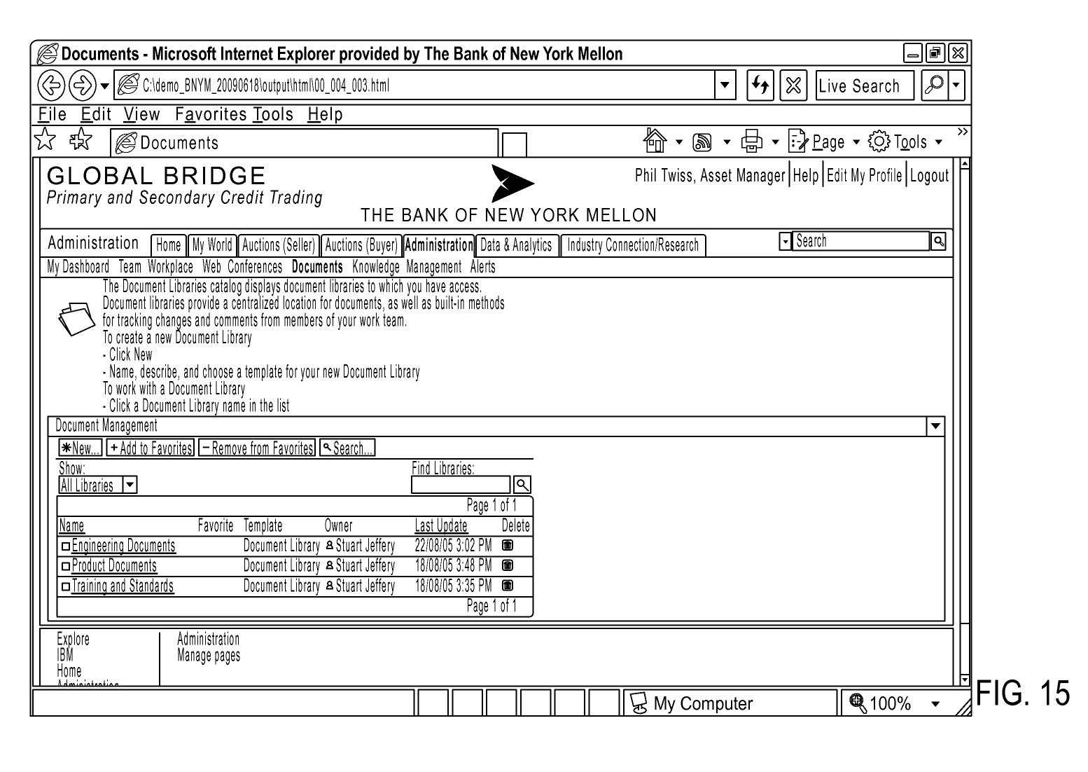

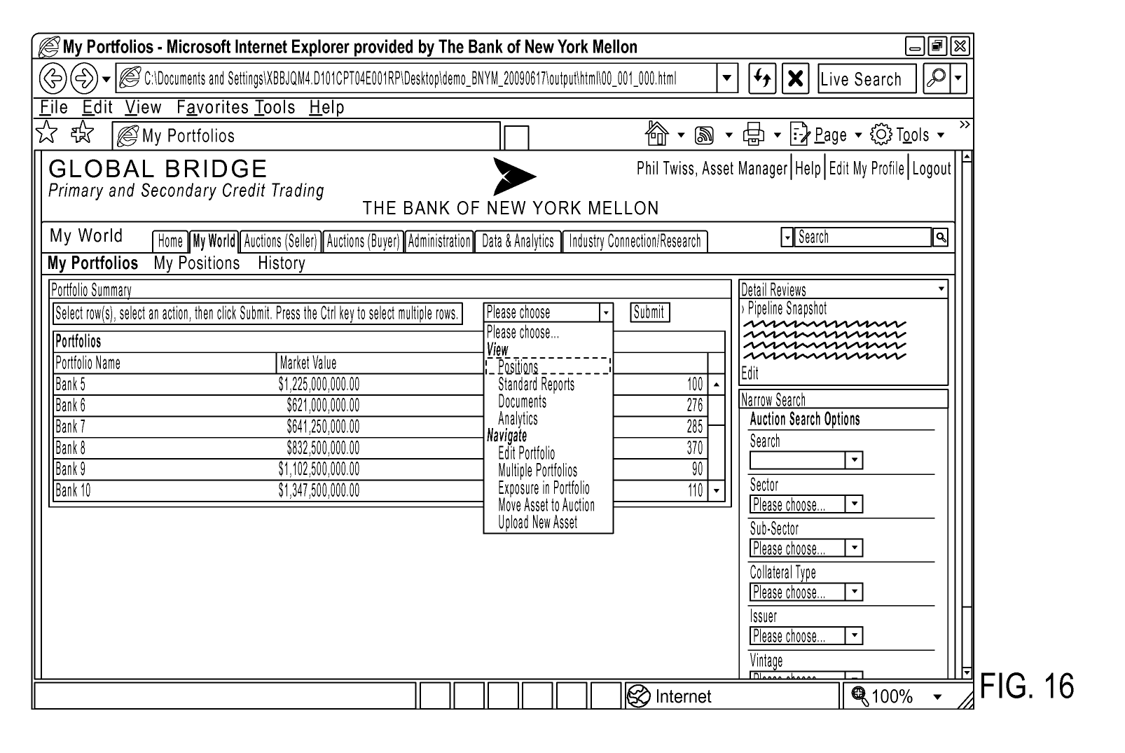

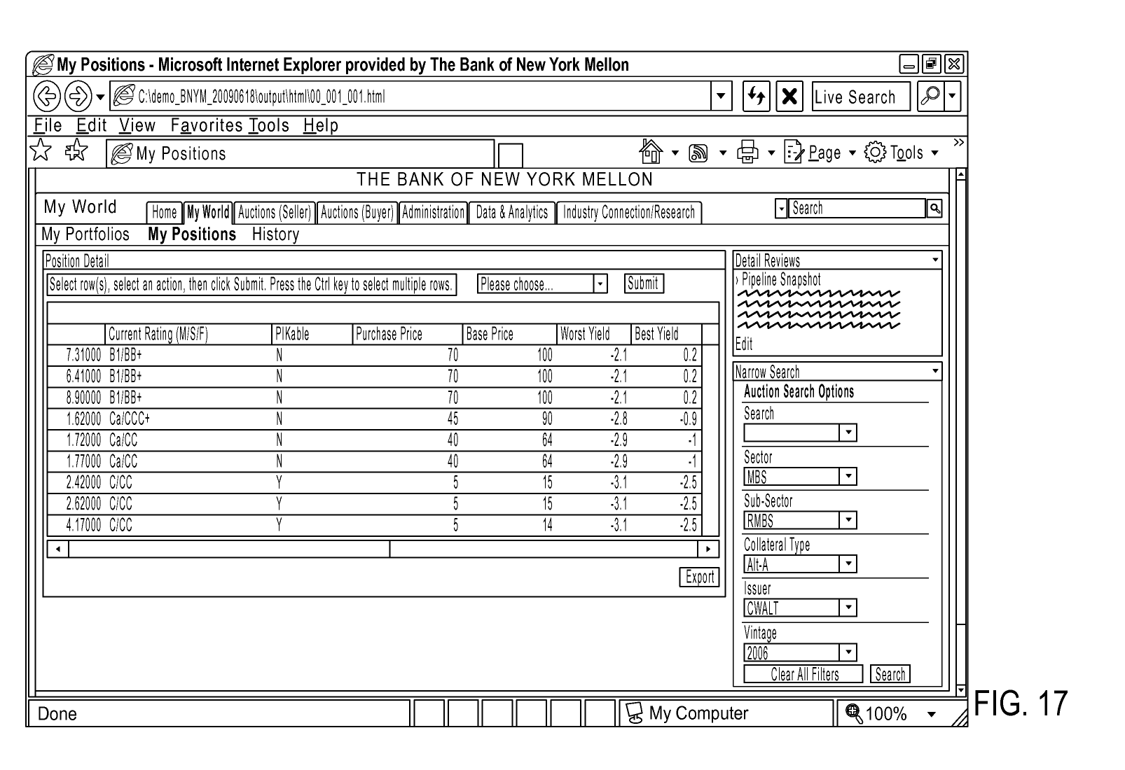

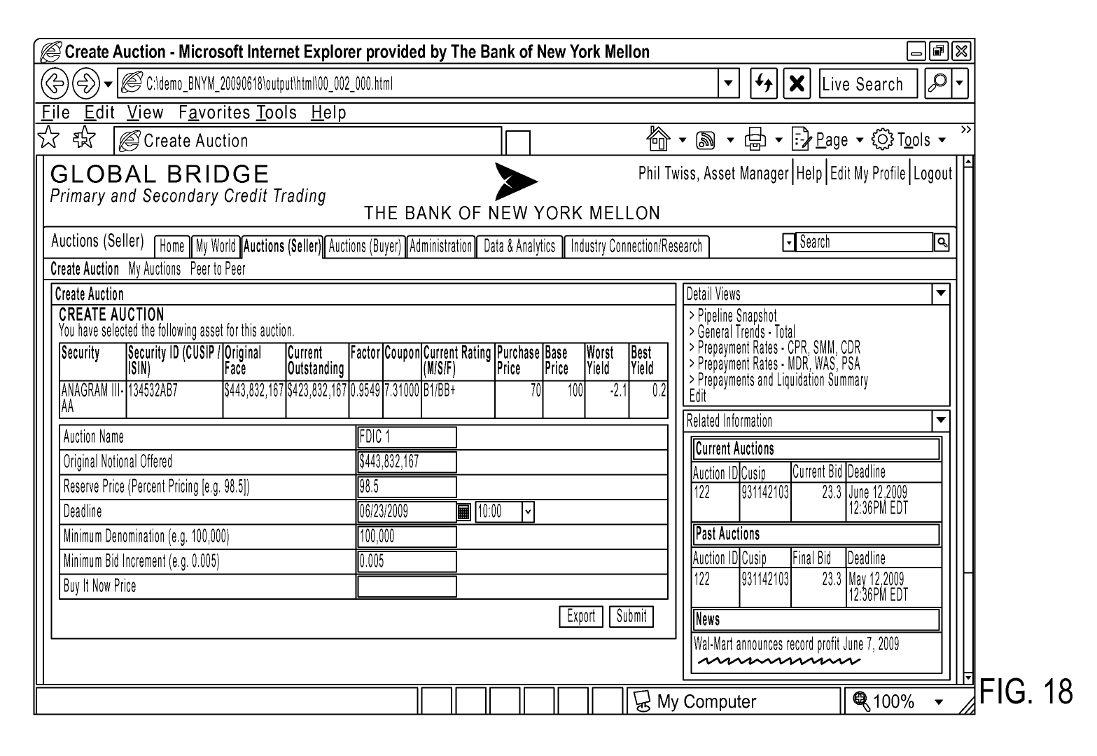

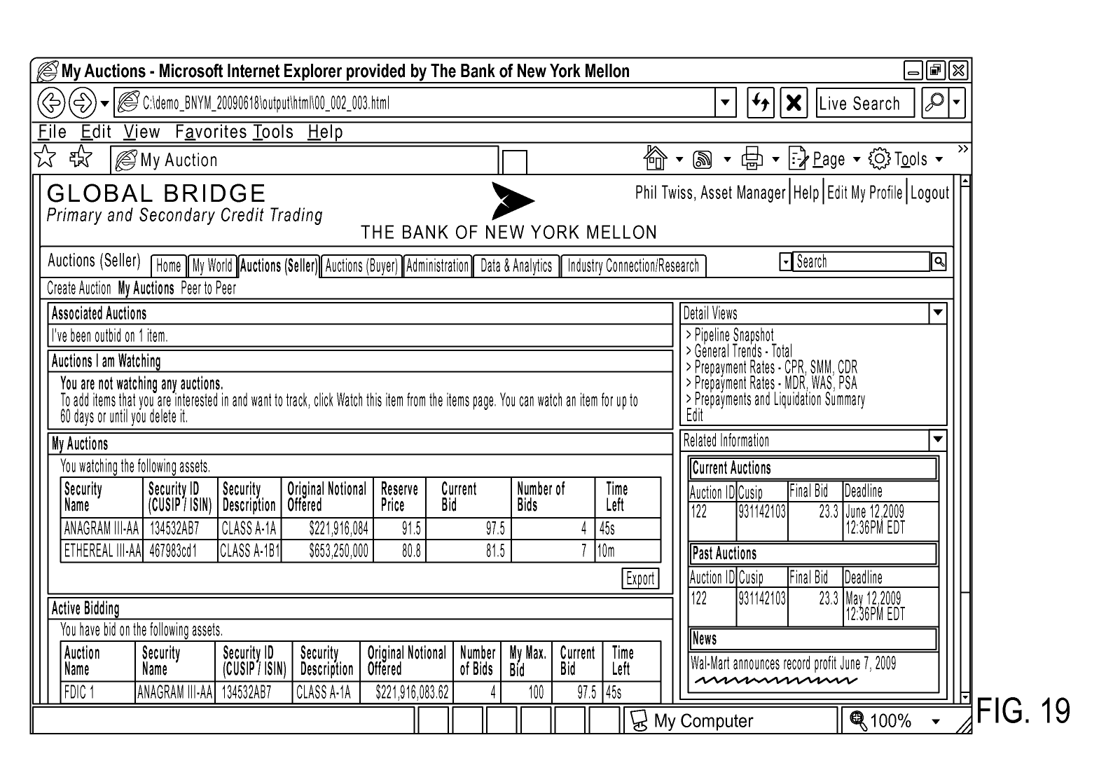

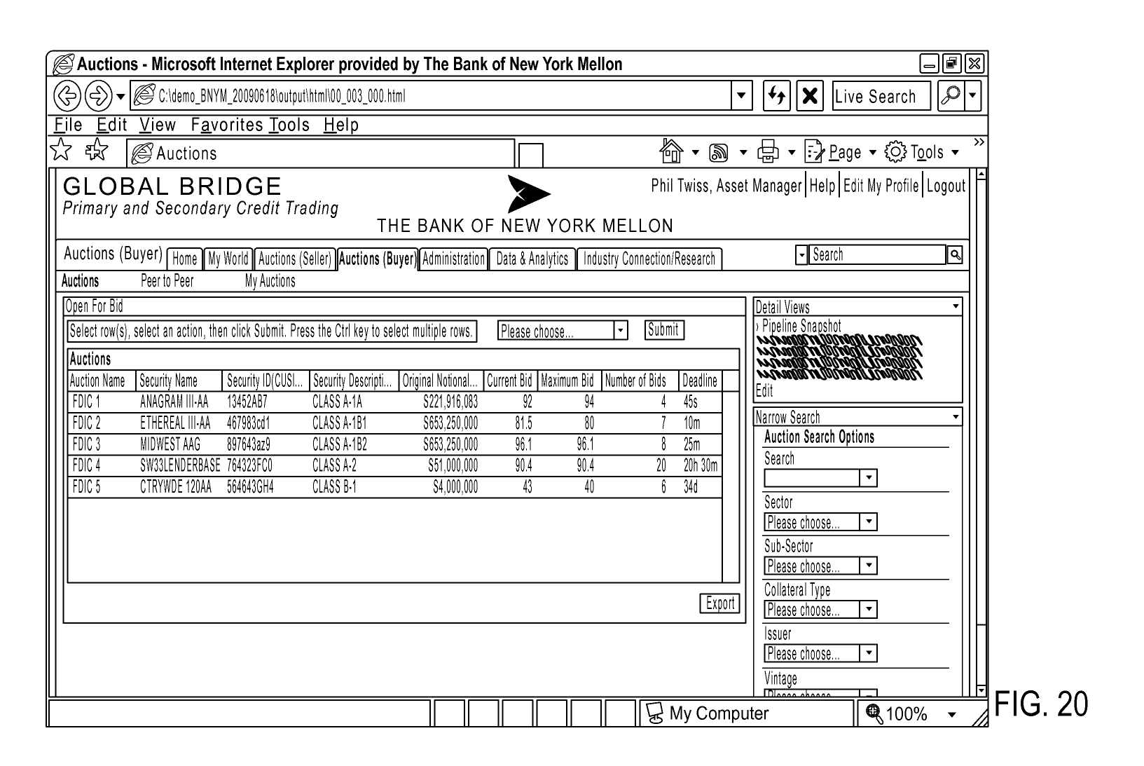

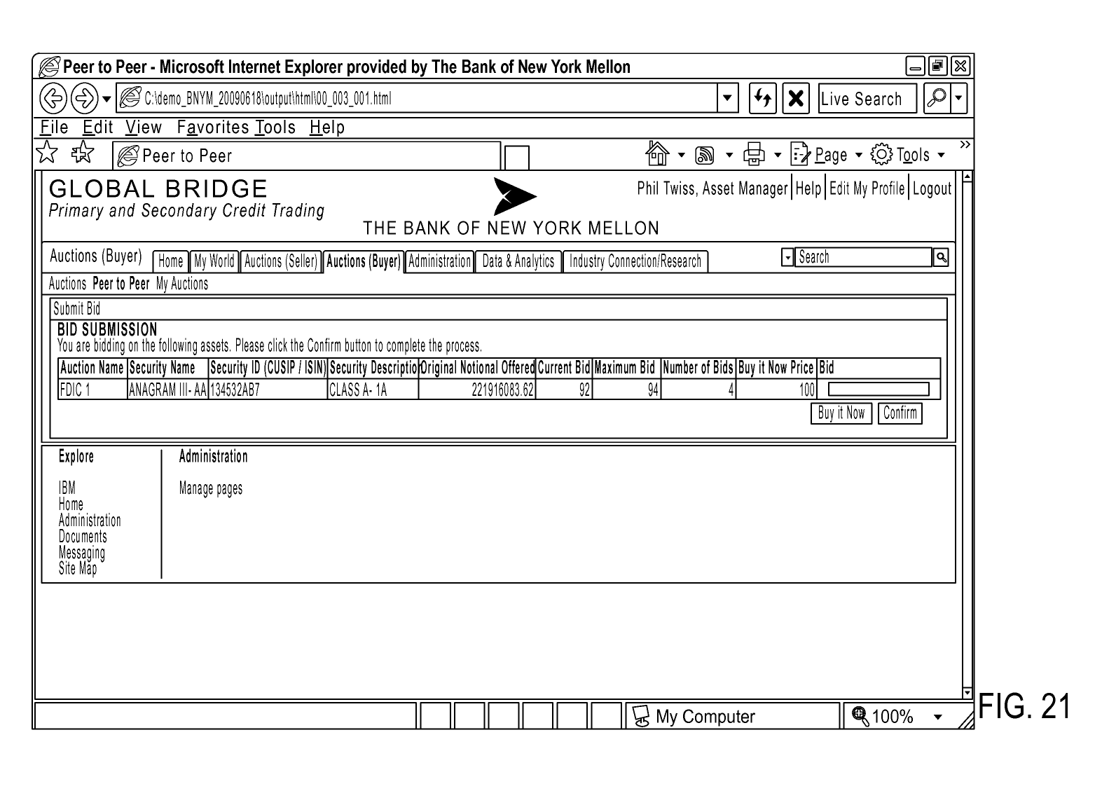

For example, FIG. 14 provides an exemplary screenshot of a participant home page. FIG. 15 provides an exemplary screenshot of an administrative page that supports document management and “drill-down” information retrieval. FIG. 16 provides an exemplary screenshot of a user's page that displays a summary of a participant's portfolio. FIG. 17 provides an exemplary screenshot of a user's page that displays a position detail for securities held by a participant. FIG. 18 provides an exemplary screenshot of a seller's page in which an auction can be created by entering various auction parameters such as an auction name, an original offering, a reserve price, the auction deadline, a minimum denomination, and minimum bid increment, for example. FIG. 19 provides an exemplary screenshot of a seller's page that displays information relating to auctions in which the seller is involved, for example, auctions in which the seller is watching and/or auctions in which the seller is simultaneously a bidder. FIG. 20 provides an exemplary screenshot of a buyer's page that displays information relating to auctions in which the buyer is involved, e.g., auctions that are open for bid, and related information about the auctions. FIG. 21 provides an exemplary screenshot of a buyer's page that displays information relating to a bid submission in an auction in which the buyer is involved, e.g., a description of the security, the current bid, the buyer's maximum bid, and the number of active bids.

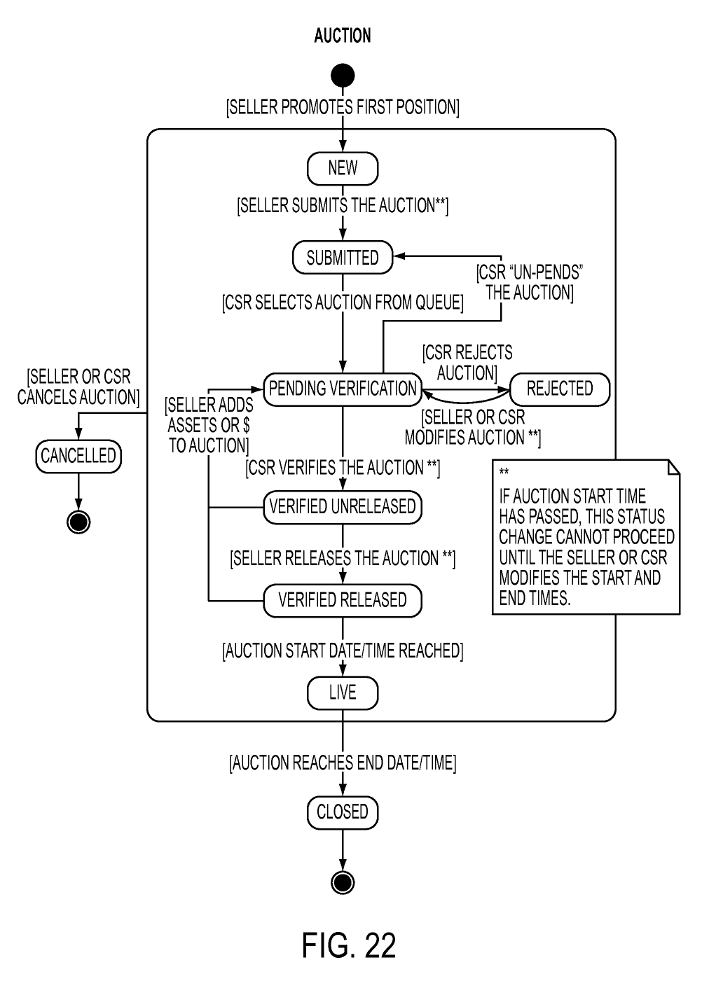

FIG. 22 provides a state flow diagram for an auction process in accordance with an embodiment in which a seller promotes and submits a first securities position for auction. The user can select an auction in “submitted” status and “pend” the auction. The system changes the auction status to “Pending Verification”, and sets an “Assigned To” field to the user's User ID, and saves the auction. Then the system refreshes the screen. The user is now responsible for verifying the auction and then marking it either “Verified Unreleased” or “Rejected”. The system may also sends out appropriate notifications to system users.

The user can select an auction that is assigned to him and is in “pending verification” status. The system can change the auction status to “Submitted” and empty the “Assigned To” field, and save the auction. Then the system refreshes the screen. The auction may then be selected by the CSR for verification. The system checks that the auction's start date/time has not already passed. If it has, the system informs the user that the auction cannot be verified until the start date/time is changed. The seller must now modify the auction. Otherwise, the system may ask the user to confirm the verification. If he does, the system changes the auction status to “verified unreleased” and saves the auction. Then the system refreshes the screen. The seller must now release the auction. The system asks the user to confirm the verification. If he does not, the system changes the auction status to “rejected” and saves the auction. Then the system refreshes the screen. The seller or CSR can now modify and resubmit the auction.

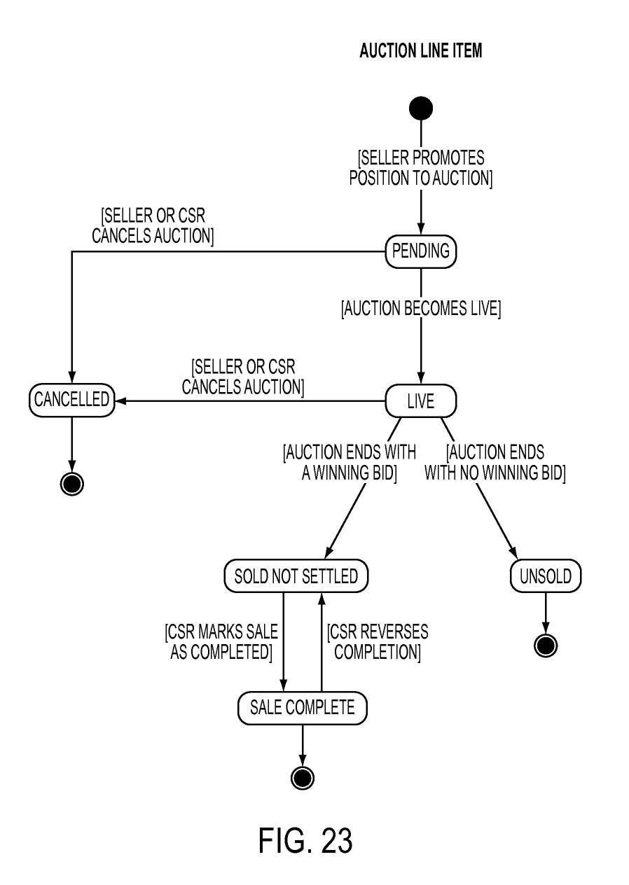

FIG. 23 provides a flow diagram related to an auction line item in which the user can select an auction that is assigned to him and is in any status except “closed”, and cancel the auction. The system asks the user to confirm the cancelation. If he does, the system changes the status of the auction, all included line items, and all bids to “canceled”. The user can select a line item in “sold not settled” status, whose auction is assigned to him and is in “closed” status, and mark the line item complete. The system asks the user to confirm the completion. If he does, the system changes the status of the line item to “sale complete”. The system may also sends out appropriate notifications. The user can select a line item in “sold complete” status, whose auction is assigned to him and is in “closed” status, and mark the line item not settled. The system asks the user to confirm the completion. If he does, the system changes the status of the line item to “sale not settled”.

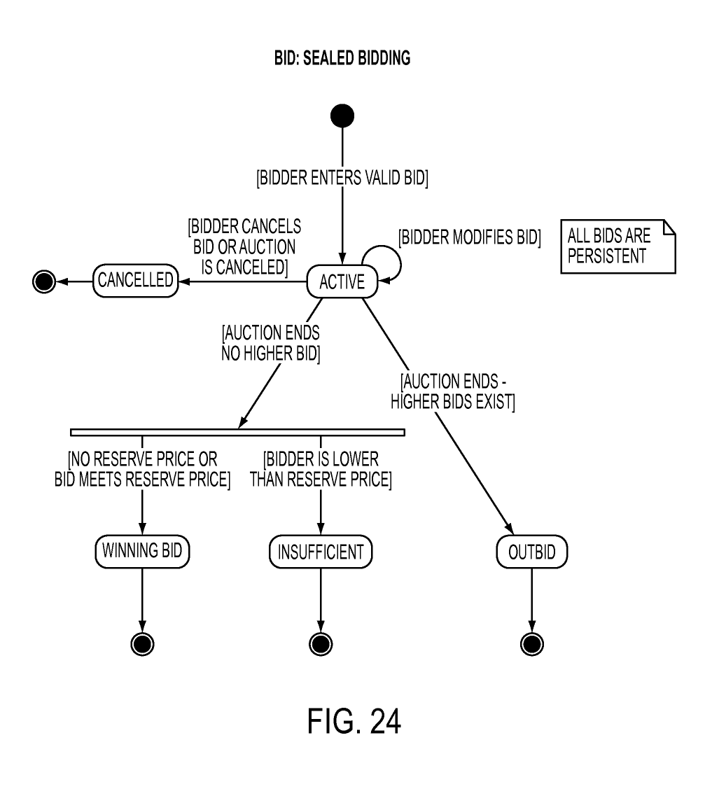

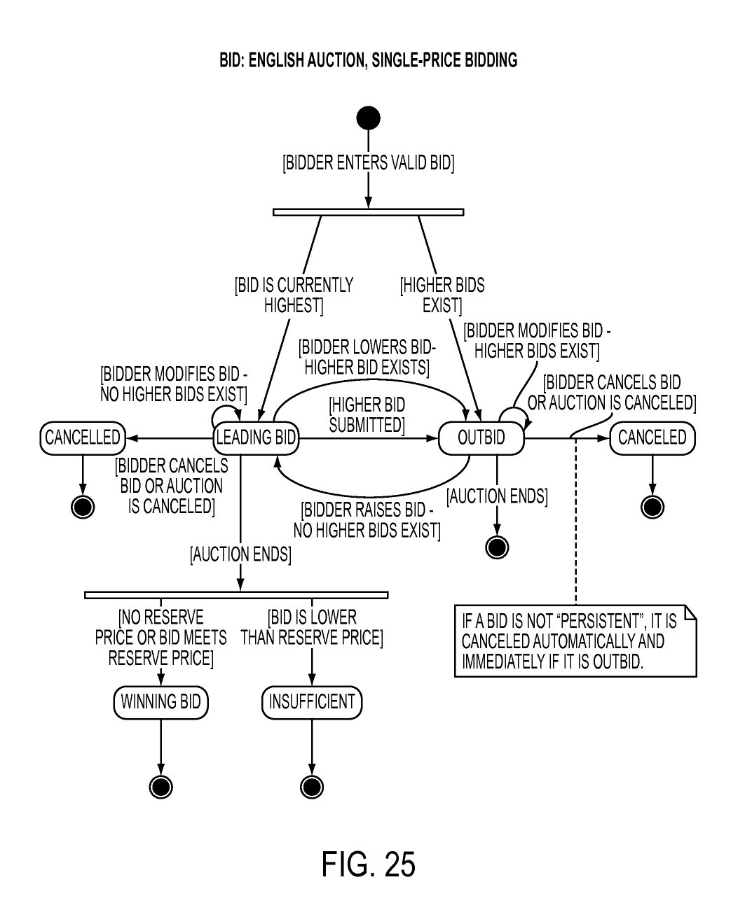

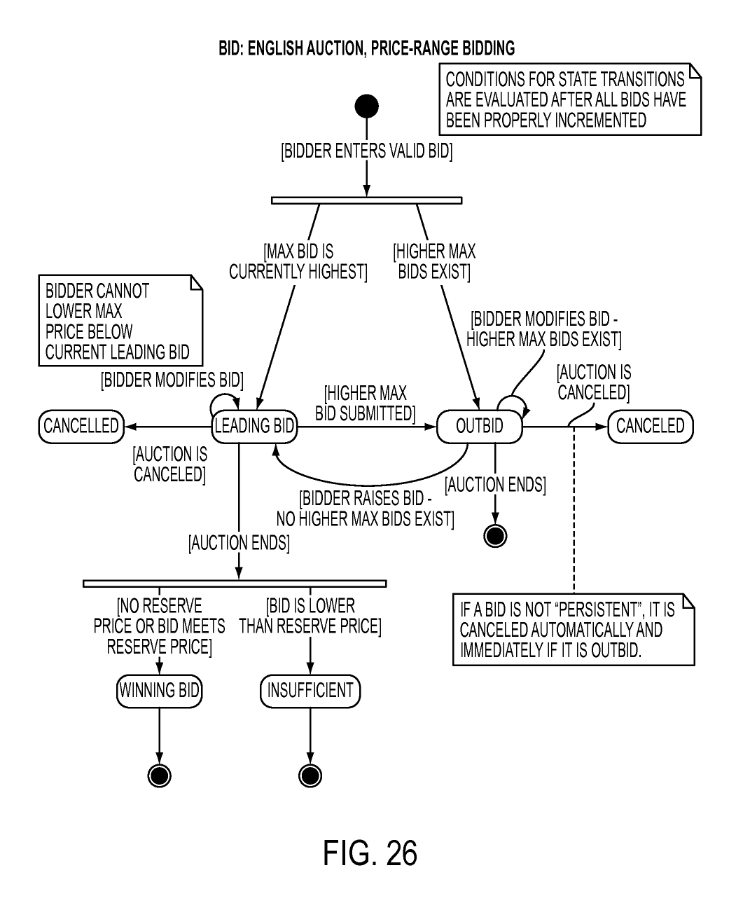

FIG. 24 provides a flow diagram related to sealed bid auction process according to an embodiment, FIG. 25 provides a flow diagram related to an English auction, single-price bidding process according to an embodiment, and FIG. 26 provides a flow diagram related to an English auction, price-range bidding process according to an embodiment. For sealed-bid auctions outlined in FIG. 24, if the bid amount is modified, the system saves the modified bid data (bid persistence does not apply as all sealed bids are persistent). If the bid is canceled, the system changes its status to “Canceled” and saves the canceled bid. For English single-bid auctions and bidding-range auctions in FIGS. 25 and 26, if the bid has been modified, e.g., if the bid amount has been changed, and if the bid was not the leading bid and the bid amount decreases, the system saves the new amount. If the bid was the leading bid and the bid amount increases, the system saves the new amount. Otherwise, the system first removes the modified bid from consideration and determines which other bid (if any) would be the leading bid by running through the list of existing bids in order of their submission date/time. When the existing bid has been modified, the date/time of its modification, not its creation, is used. The system further determines whether each bid in turn becomes the leading bid and, if so, what its current bid amount would be. The system then treats the modified bid as a new bid and determines if it is the leading bid on the line item. This may affect the status and/or bid amounts of other bids. After any changes to bid amounts have been processed, if the persistence of the bid has been changed, the system saves the new setting. If the bid has been canceled, the system changes its status to “Canceled” and saves the canceled bid. The system then determines which other bid (if any) is the leading bid. This may affect the status and/or bid amounts of other bids. For each bid record added, updated, or canceled, the system saves a bid history record capturing the event and the changes made for audit and recordkeeping purposes.

After a successful bid, the modified bid is saved, and other bids are updated or canceled as appropriate. The bidding history is saved for all bids affected.

The system will automatically close an auction at a pre-determined date and time. Triggers include that the time is “Y” minutes (i.e., a user-selectable time) prior to the scheduled end date and time for an auction, or that the time is “Y” minutes prior to the extended end date and time for an extended auction. When the time reaches “Y” minutes prior to the scheduled end date and time for a Live auction, the system sends an “auction ending shortly” notice to the seller. If an auction has been extended, the extended end date and time determine the auction's closing. “Y” is a number of minutes that is configurable, e.g., 30 minutes. Later, when the time reaches “X” minutes past the scheduled end date and time for a live auction, the system changes the status of the auction to “Closed”. If an auction has been extended, the extended end date and time determine the auction's closing. Similarly, “X” is a number of minutes that is user configurable, for example, one minute. Once the auction is closed, the system does not accept any further bids for the auction. The system displays the auction as closed as soon as the end date and time is reached, even though bidding closes “X” minutes afterwards.

In all embodiments, the system determines the potential winning bid. For sealed-bid auctions in FIG. 24, the highest active bid at the time the auction closes is the potential winning bid. The system changes the status of any other bids for the line item to “outbid”. For English single-bid auctions and bidding-range auctions in FIGS. 25 and 26, the leading bid at the time the auction closes is the potential winning bid. If the item has no reserve price, or if the potential winning bid amount is greater than or equal to the reserve price, then the potential winning bid becomes the winning bid for the item. The system then changes the line item's status to “sold not settled”, and changes the winning bid's status to “winning bid”. If the potential winning bid amount is less than the item's reserve price, there is no winning bid for that item, and the system changes the line item's status to “unsold”, and changes the status of the potential winning bid to “insufficient”. For each bid record updated, the system saves a bid history record capturing the event and the changes made.

Various embodiments herein are described as including a particular feature, structure, or characteristic, but every aspect or embodiment may not necessarily include the particular feature, structure, or characteristic. Further, when a particular feature, structure, or characteristic is described in connection with an embodiment, it will be understood that such feature, structure, or characteristic may be included in connection with other embodiments, whether or not explicitly described. Thus, various changes and modifications may be made to this disclosure without departing from the scope or spirit of the inventive concept described herein. As such, the specification and drawings should be regarded as examples only, and the scope of the inventive concept to be determined solely by the appended claims.

What we claim is:

1. A computer-implemented method of evaluating and auctioning financial instruments on an auction platform, the method comprising:
providing a processor, memory device, at least one user interface, and a network connection operatively interconnected in the auction platform;
registering, in a database in the memory device, auction participants that have provided required participant information via the auction platform, said auction participants at least comprising one or more registered sellers and/or one or more registered buyers;
storing, in the database, an inventory of financial instruments received from a registered seller via the auction platform;
initiating an auction event for a selected one or more of the inventoried financial instruments in response to an auction request received from the registered seller via the auction platform;
providing integrated direct access for a registered buyer to a data and analytics tool via the auction platform,
said data and analytics tool comprising computer-implemented cash flow modeling that enables the registered buyer to carry out investment cash flow analysis and to assess underlying risk of default associated with the selected one or more of the inventoried financial instruments based upon one or more assumptions input to the auction platform by the registered buyer and past performance data related to the selected one or more of the inventoried financial instruments,
wherein said cash flow analysis and said underlying risk assessment are used by said registered buyer to determine a bid price or bid range for said selected one or more of the inventoried financial instruments.

2. The method of claim 1, further comprising submitting either the bid price or said bid range, or both, via the auction platform in connection with the initiated auction event.

3. The method of claim 1, further comprising:
storing a reserve price associated with the selected one or more of the inventoried financial instruments in the database; and
allowing the registered seller to cancel the initiated auction event via the user interface if a received bid is less than the reserve price.

4. The method of claim 1, further comprising storing a closing date/time for the initiated auction event in the database.

5. The method of claim 1, further comprising:
storing a reserve price associated with the selected one or more of the inventoried financial instruments in the database; and
automatically cancelling the initiated auction event via the processor if a received bid is less than the stored reserve price.

6. The method of claim 1, wherein the financial instruments are one or more financial instruments selected from of the group consisting of a residential mortgage-backed security (RMBS), an asset-backed security (ABS), a commercial mortgage backed security (CMBS), a collateralized debt obligation (CDO), a collateralized mortgage obligation (CMO), and a whole-loan pool.

7. The method of claim 1, further comprising registering platform users in the database that have provided required user information via the auction platform, said platform users being given one or more entitlements to view and/or manage auction-related information in the auction platform.

8. The method of claim 1, wherein said data and analytics tool provides access to loan data underlying one or more of the inventoried financial instruments.

9. The method of claim 1, wherein said data and analytics tool provides access to documents related to one or more of the inventoried financial instruments.

10. The method of claim 1, further comprising clearing and settling a completed auction event between the registered seller and the registered buyer through a networked interface between the auction platform and a central securities depository (CSD).

11. The method of claim 10, wherein said clearing and settling is carried out anonymously between the registered seller and the registered buyer by the CSD.

12. The method of claim 1, wherein said initiated auction event comprises an auction style selected from the group consisting of a sealed bid auction, an English auction with single price, and an English auction with bid range.

13. The method of claim 1, further comprising storing escrow data in the database during pendency of the initiated auction event, said escrow data representing an escrow account associated with the selected one or more of the inventoried financial instruments and maintained by a broker/dealer,
wherein said processor provides an indication to the database that the selected one or more of the inventoried financial instruments is unavailable for trade until the auction event is either completed or cancelled.

14. The method of claim 1, wherein said processor is configured to store a bid history for each inventoried financial instrument associated with each auction event processed by the auction platform.

15. The method of claim 1, wherein said integrated direct access to the data and analytics tool is provided internally to said auction platform.

16. The method of claim 1, wherein said integrated direct access to the data and analytics tool is provided via the network connection to an external tool outside of said auction platform.

17. The method of claim 1, further comprising extending a duration of a live auction event via the at least one user interface.

18. The method of claim 1, further comprising canceling the auction event via the at least one user interface.

19. A system for computerized evaluation and auctioning of financial instruments, the system comprising:
an auction platform comprising an operatively interconnected processor, a memory device, at least one user interface, and a network connection;
a structured database arranged in the memory device and configured to store registration information received over the network connection, said registration information pertaining to auction participants that have provided required participant information via the auction platform, said auction participants at least comprising one or more registered sellers and/or one or more registered buyers;
wherein the processor is configured:
to store, in the database, an inventory of financial instruments received from a registered seller via the auction platform;
to initiate an auction event for a selected one or more of the inventoried financial instruments in response to an auction request received from the registered seller via the auction platform; and
a computer interface to an integrated data and analytics tool, said integrated data and analytics tool providing direct access for a registered buyer to a computer-implemented cash flow model that enables the registered buyer to carry out investment cash flow analysis and to assess underlying risk of default associated with the selected one or more of the inventoried financial instruments based upon one or more assumptions input to the integrated data and analytics tool via the computer interface and past performance data related to the selected one or more of the inventoried financial instruments,
wherein said cash flow analysis and said underlying risk assessment are used by said registered buyer to determine a bid price or bid range for said selected one or more of the inventoried financial instruments.

20. The system of claim 19, wherein the at least one user interface is configured to receive, in connection with the initiated auction event, either the bid price or said bid range, or both, from the registered buyer via the at least one user interface.

21. The system of claim 19, wherein the processor is further configured to store a reserve price associated with the selected one or more of the inventoried financial instruments in the database; and to allow the registered seller to cancel the initiated auction event via the user interface if a received bid is less than the reserve price.

21. The system of claim 19, wherein the processor is further configured to store a closing date/time for the initiated auction event in the database, said closing date/time being received via the at least one user interface.

23. The system of claim 19, wherein the processor is further configured to:
store a reserve price associated with the selected one or more of the inventoried financial instruments in the database; and
automatically cancel the initiated auction event via the processor if a received bid is less than the stored reserve price.

24. The system of claim 19, wherein the database is configured to store information concerning financial instruments that are selected from the group consisting of a residential mortgage-backed security (RMBS), an asset-backed security (ABS), a commercial mortgage backed security (CMBS), a collateralized debt obligation (CDO), a collateralized mortgage obligation (CMO), and a whole-loan pool.

25. The system of claim 19, wherein the processor is further configured to register platform users in the database that have provided required user information via the auction platform, said platform users being given one or more entitlements to view and/or manage auction-related information in the auction platform.

26. The system of claim 19 wherein said data and analytics tool is configured to provide access to loan data underlying one or more of the inventoried financial instruments.

27. The system of claim 19, wherein said data and analytics tool is configured to provide access to documents related to one or more of the inventoried financial instruments.

28. The system of claim 19, wherein the processor is further configured to initiate a clearing and settling operation for a completed auction event between the registered seller and the registered buyer through a networked interface between the auction platform and a central securities depository (CSD).

29. The system of claim 28, wherein said clearing and settling operation is carried out anonymously between the registered seller and the registered buyer by the CSD.

30. The system of claim 19, wherein said initiated auction event comprises an auction style selected from the group consisting of a sealed bid auction, an English auction with single price, and an English auction with bid range.

31. The system of claim 19, wherein the processor is further configured to store escrow data in the database during pendency of the initiated auction event, said escrow data representing an escrow account associated with the selected one or more of the inventoried financial instruments and maintained by a broker/dealer,
wherein the processor stores an indication in the database that the selected one or more of the inventoried financial instruments is unavailable for trade until the auction event is either completed or cancelled.

32. The system of claim 19, wherein said processor is configured to store a bid history for each inventoried financial instrument associated with each auction event processed by the auction platform.

33. The system of claim 19, wherein said direct access to the data and analytics tool is provided internally to said auction platform.

34. The system of claim 19, wherein said direct access to the data and analytics tool is provided via the network connection to an external tool outside of said auction platform.

35. The system of claim 19, wherein said processor is configured to extend a duration of a live auction event in response to an extension request received via the at least one user interface.

36. The system of claim 19, wherein said processor is configured to cancel an auction event in response to a cancellation request received via the at least one user interface.

37. The system of claim 19, wherein the integrated data and analytics tool allows a user thereof to perform a due diligence analysis of the selected one or more of the inventoried financial instruments via the user interface to determine a price evaluation independent of a reserve price thereof.

38. The system of claim 19, wherein the integrated data and analytics tool is configured to perform a sensitivity analysis of a price evaluation responsive to user-entered input of security valuation parameters and/or variables related thereto.

39. The system of claim 19, further comprising a direct links via a computer interface to a service provider infrastructure relating to cash, custody, and clearance to provide direct settlement for auction participants.

40. The system of claim 19, wherein the processor is further configured to provide an electronic notification report to an oversight agency regarding activities and performance of auction participants.

41. An article of manufacture comprising a tangible computer-readable medium therein, said computer-readable medium containing computer-readable instructions thereon which, when executed by a computer processor, cause the processor to carry out functions related to evaluating and auctioning financial instruments on an auction platform, the functions comprising:
registering, in a database in a memory device, auction participants that have provided required participant information via the auction platform, said auction participants at least comprising one or more registered sellers and/or one or more registered buyers;
storing, in the database, an inventory of financial instruments received from a registered seller via the auction platform;
initiating an auction event for a selected one or more of the inventoried financial instruments in response to an auction request received from the registered seller via the auction platform;
providing integrated direct access for a registered buyer to a data and analytics tool via the auction platform,
said data and analytics tool comprising computer-implemented cash flow modeling that enables the registered buyer to carry out investment cash flow analysis and to assess underlying risk of default associated with the selected one or more of the inventoried financial instruments based upon one or more assumptions input to the auction platform by the registered buyer and past performance data related to the selected one or more of the inventoried financial instruments,
wherein said cash flow analysis and said underlying risk assessment are used by said registered buyer to determine a bid price or bid range for said selected one or more of the inventoried financial instruments.
